(19) United States
(12) Patent Application Publication
(10) Pub. No.: US 2018/0276127 A1
(43) Pub. Date: Sep. 27, 2018

(54) INFORMATION PROCESSING SYSTEM, INFORMATION PROCESSING APPARATUS, AND METHOD OF CONTROLLING INFORMATION PROCESSING SYSTEM

(71) Applicant: FUJITSU LIMITED, Kawasaki-shi (JP)

(72) Inventor: Katsuya Ishiyama, Kawasaki (JP)

(73) Assignee: FUJITSU LIMITED, Kawasaki-shi (JP)

(21) Appl. No.: 15/907,345

(22) Filed: Feb. 28, 2018

(30) Foreign Application Priority Data
Mar. 23, 2017 (JP) 2017-058086

(51) Int. Cl. G06F 12/0831; G06N 99/00

(52) U.S. Cl. CPC G06F 12/0835; G06F 2212/621; G06N 99/005

(57) ABSTRACT

An information processing system includes: a first information processing apparatus; and a second information processing apparatus, the first information processing apparatus includes: a computation processing device that executes a first computation; a main storage device that stores data; and a control device that controls transfer of data among the first and second information processing apparatuses, the control device includes: a computation processor that executes a second computation; a buffer that holds data used in the second computation that the computation processor executes; and a transfer controller that controls transfer of data from the main storage device to the buffer and transfer of data from a different main storage device in the second information processing apparatus to the buffer, and controls transfer of result data of the second computation to the main storage device and transfer of the result data of the second computation to the different main storage device.

### CROSS-REFERENCE TO RELATED APPLICATION

This application is based upon and claims the benefit of priority of the prior Japanese Patent Application No. 2017-58086, filed on Mar. 23, 2017, the entire contents of which are incorporated herein by reference.

### FIELD

The embodiments discussed herein are related to an information processing system, an information processing apparatus, and a method of controlling an information processing system.

### BACKGROUND

Processing such as deep learning is executed by using an information processing system that includes a plurality of nodes and executes computations in parallel.

Related technologies are disclosed in International Publication Pamphlet No. WO 2011/058640, Japanese Laid-open Patent Publication Nos. 2015-233178 and 8-115213.

### SUMMARY

According to an aspect of the embodiments, an information processing system includes: a first information processing apparatus; and a second information processing apparatus, the first information processing apparatus includes: a computation processing device that executes a first computation; a main storage device that stores data; and a control device that controls transfer of data among the first information processing apparatus and the second information processing apparatus, the control device includes: a computation processor that executes a second computation; a buffer that holds data to be used in the second computation that the computation processor executes; and a transfer controller that controls transfer of data from the main storage device to the buffer and transfer of data from a different main storage device included in the second information processing apparatus to the buffer, and controls transfer of result data of the second computation to the main storage device and transfer of the result data of the second computation to the different main storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates one example of an information processing system, an information processing apparatus, and a method of controlling an information processing system;

FIG. 2 illustrates one example of an operation of the information processing system illustrated in FIG. 1;

FIG. 3 illustrates one example of an operation of another information processing system different from the information processing system illustrated in FIG. 1;

FIG. 4 illustrates one example of an information processing system, an information processing apparatus, and a method of controlling an information processing system;

FIG. 5 illustrates one example of a DMA unit illustrated in FIG. 4;

FIG. 6 illustrates one example of an operation of the DMA unit illustrated in FIG. 5;

FIG. 7 illustrates one example of formats of packets used in the information processing system illustrated in FIG. 4;

FIG. 8 illustrates one example (continued from FIG. 7) of formats of packets used in the information processing system illustrated in FIG. 4;

FIG. 9 illustrates one example of an operation of a DMA engine illustrated in FIG. 4;

FIG. 10 illustrates one example of a relation between data stored in the memories of the respective nodes illustrated in FIG. 4 and a node responsible for a reduce computation;

FIG. 11 illustrates one example of an operation in which the respective nodes collect data, and execute in parallel the reduce computations, in the information processing system illustrated in FIG. 4;

FIG. 12 illustrates one example of an operation of distributing the result data of the reduce computations that the respective nodes have executed in parallel in FIG. 9;

FIG. 13 illustrates one example of an operation of the information processing system illustrated in FIG. 4;

FIG. 14 illustrates one example (continued from FIG. 13) of the operation of the information processing system illustrated in FIG. 4;

FIG. 15 illustrates one example of an operation flow of a master illustrated in FIGS. 13 and 14;

FIG. 16 illustrates one example of an operation flow of a slave illustrated in FIGS. 13 and 14;

FIG. 17 illustrates one example of deep learning that the information processing system illustrated in FIG. 4 executes;

FIG. 18 illustrates one example of another information processing system different from the information processing system illustrated in FIG. 4;

FIG. 19 illustrates one example of an operation of a DMA engine illustrated in FIG. 18;

FIG. 20 illustrates one example of an operation of the information processing system illustrated in FIG. 18;

FIG. 21 illustrates one example of an operation of the information processing system; and

FIG. 22 illustrates one example of an operation of the information processing system.

### DESCRIPTION OF EMBODIMENTS

In processing such as deep learning, executed is allreduce processing in which each node executes the computation using data collected from the other nodes, and, for example, the computation result of each node is broadcast to all the other nodes. For example, in a signal processing apparatus including a central processing unit (CPU), a digital signal processor (DSP), and a direct memory access controlling unit (DMAC), DMA transfer between each of a plurality of memories in the DSP and an external device is executed based on a DMA instruction embedded in a program that the DSP executes. Accordingly, without increasing the load to the CPU, the data transfer between each memory and the external device and the computation of data by the DSP are executed in parallel.

In allreduce processing, data for computation stored in main storage devices of a plurality of nodes is transmitted to the main storage devices of all the other nodes, each node executes the computation of the data stored in the main storage device, and stores result data obtained by the computation in the main storage device. Thereafter, each node distributes the result data stored in the main storage device to the other nodes. The computation processing device such as the CPU provided in each node is unable to execute another computation while the computation of the data held in the main storage device is being executed.

For example, in an information processing system in which a plurality of information processing apparatuses each execute a computation using data having been mutually transferred, and transfer result data obtained by the computation to each information processing apparatus, in each information processing apparatus, the processing performance of another computation other than the computation with respect to the transferred data may preferably be suppressed from being lowered.

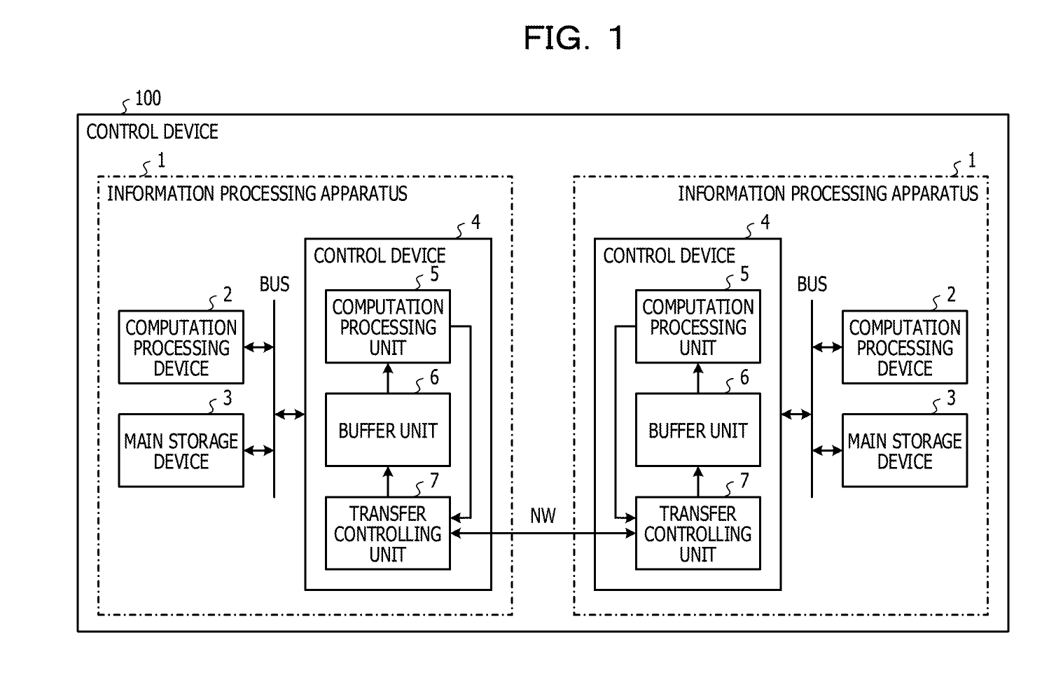

FIG. 1 illustrates one example of an information processing system, an information processing apparatus, and a method of controlling an information processing system. An information processing system 100 illustrated in FIG. 1 includes a plurality of information processing apparatuses 1 that are mutually coupled via a network NW. The number of the information processing apparatuses 1 included in the information processing system 100 is not limited to two. Each of the information processing apparatuses 1 includes a computation processing device 2, a main storage device 3, and a control device 4. For example, the computation processing device 2, the main storage device 3, and the control device 4 are mutually coupled via a common bus BUS.

The computation processing device 2 includes, for example, a plurality of computing elements that execute FMA(fused multiply-add) operations and the like. The FMA operation is one example of a first computation. The main storage device 3 stores therein data used in the computation that the computation processing device 2 executes and data used in the computation that a computation processing unit 5, which is described later, executes. The control device 4 controls transfer of data between the plurality of the information processing apparatuses 1. Hereinafter, each information processing apparatus 1 is also referred to as a node.

The control device 4 includes the computation processing unit 5, a buffer unit 6, and a transfer controlling unit 7. For example, the buffer unit 6 is coupled to the transfer controlling unit 7 and the computation processing unit 5, without going through the common bus BUS or the like. The computation processing unit 5 includes, for example, a plurality of adders and a plurality of dividers, and calculates a mean value for every a plurality pieces of data. The computation to calculate a mean value of data by the adders and the dividers is one example of a second computation. The buffer unit 6 holds data that is data used in the computation that the computation processing unit 5 executes, and is transferred from the main storage device 3.

The transfer controlling unit 7 executes control to transfer data from the main storage device 3 of the local node to the buffer unit 6 of the local node, and executes control to transfer data from the main storage device 3 of the other node to the buffer unit 6 of the local node. Moreover, the transfer controlling unit 7 executes control to transfer, using data stored in the buffer unit 6 of the local node, result data of the computation that the computation processing unit 5 of the local node has executed to the main storage device 3 of the local node and the main storage device 3 of the other node. Hereinafter, the computation that is executed by target data for the computation being collected from the local node and the other node and the collected data being used, is also referred to as a reduce computation.

Each of the plurality of the information processing apparatuses 1 illustrated in FIG. 1 stores data held in the main storage devices 3 of the local node and of the other nodes in the buffer unit 6 of the local node, and executes the reduce computation using the data stored in the buffer unit 6, by the computation processing unit 5. Further, each of the information processing apparatuses 1 transmits result data that is obtained from the reduce computation by the computation processing unit 5 to the local node and all the other nodes to accordingly store the result data in the main storage devices 3 of the local node and all the other nodes. In other words, the information processing system 100 executes the allreduce processing.

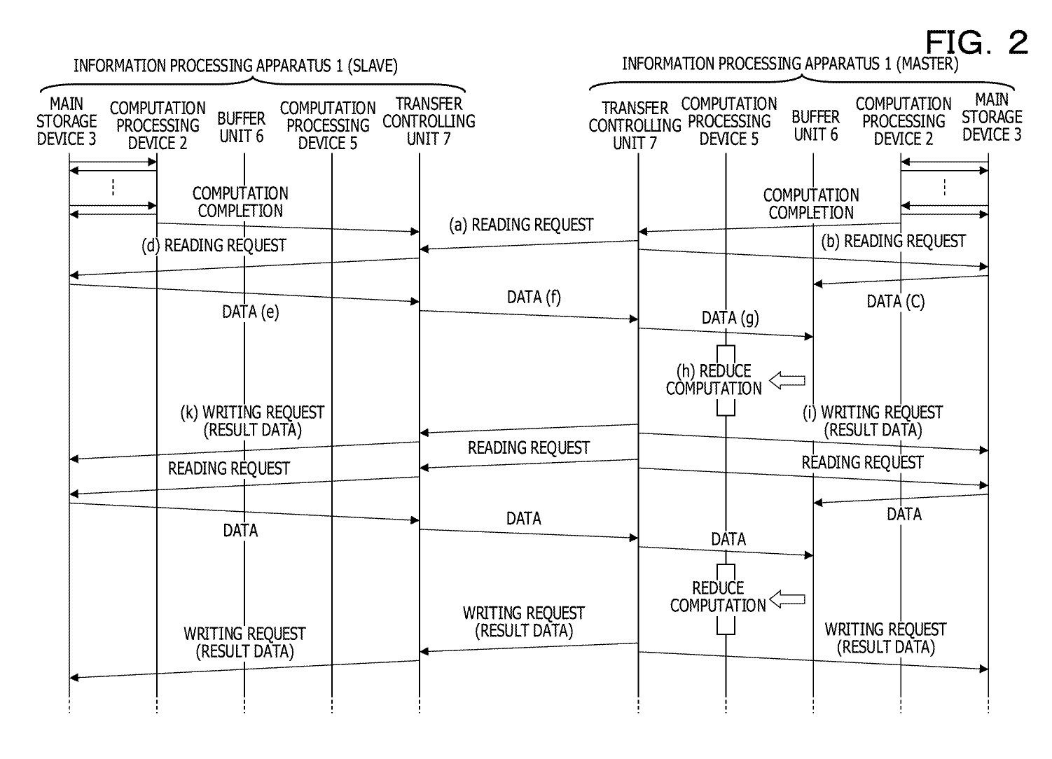

FIG. 2 illustrates one example of an operation of the information processing system illustrated in FIG. 1. Each information processing apparatus 1 illustrated in FIG. 2 executes in parallel am operation as a master and an operation as a slave. For example, the operation as a master and the operation as a slave are executed in each of all the information processing apparatuses 1.

Each information processing apparatus 1 causes the computation processing device 2 to operate to read data from the main storage device 3, executes the computation processing such as the FMA operation, and stores the computation result as data to be used in the reduce computation in the main storage device 3 of the local node. Based on the completion of the computations in the computation processing devices 2 of all the information processing apparatuses 1, the transfer controlling unit 7 of the information processing apparatus 1 that operates as a master issues a reading request to the different information processing apparatus 1 ((a) of FIG. 2). The reading request that is issued to the different information processing apparatus 1, based on the completion of the computation in the computation processing device 2, is one example of a transfer request for data. Moreover, the transfer controlling unit 7 issues a reading request to the main storage device 3 of the local node, and stores data read from the main storage device 3 in the buffer unit 6 ((b) and (c) of FIG. 2).

The transfer controlling unit 7 of the information processing apparatus 1 that operates as a slave issues, when having received a reading request from the different information processing apparatus 1, a reading request to the main storage device 3 of the local node, and reads data from the main storage device 3 ((d) and (e) of FIG. 2). Further, the transfer controlling unit 7 outputs the data read from the main storage device 3 to the information processing apparatus 1 that operates as a master ((f) of FIG. 2). The transfer controlling unit 7 of the information processing apparatus 1 that operates as a master stores the data received from the information processing apparatus 1 that operates as a slave, in the buffer unit 6 ((g) of FIG. 2). In the following explanation, the transfer controlling unit 7 of the information processing apparatus 1 that operates as a master is also referred to as the transfer controlling unit 7 (master).

The buffer unit 6 illustrated in FIG. 1 is coupled to the transfer controlling unit 7, without going through the bus BUS or the like. This may shorten the transfer time of data from the transfer controlling unit 7 to the buffer unit 6, compared with the transfer time of data from the transfer controlling unit 7 to the main storage device 3.

After the transfer of data from the main storage devices 3 of all the information processing apparatuses 1 to the buffer unit 6 has been completed, the computation processing unit 5 of the information processing apparatus 1 that operates as a master executes the reduce computation using the data held in the buffer unit 6 ((h) of FIG. 2). The data used in the reduce computation is stored in the buffer unit 6, therefore, it is possible to execute the reduce computation without providing a memory area in which the data used in the reduce computation is stored in the main storage device 3. Moreover, the buffer unit 6 is coupled to the computation processing unit 5 without going through the common bus BUS or the like, therefore, it is possible to shorten the transfer time of data from the buffer unit 6 to the computation processing unit 5, compared with the transfer time of data from the main storage device 3 to the computation processing unit 5.

The reduce computation that the computation processing unit 5 executes is, for example, the computation to calculate a mean value of data read from the respective main storage devices 3 of the plurality of the information processing apparatuses 1. Data transferred from each main storage device 3 to the buffer unit 6 is, for example, array data including a plurality pieces of element data. The computation processing unit 5 takes out element data from each of a plurality pieces of array data, and calculates a mean value for every taken-out element data. For example, the computation processing unit 5 repeatedly executes a plurality of reduce computations.

The reduce computation is executed in such a manner that the computation processing unit 5 accesses the buffer unit 6, and thus is executed without using the computation processing device 2 and is executed without the main storage device 3 being accessed. This allows the computation processing device 2 to access the main storage device 3 and execute another computation processing while the computation processing unit 5 is executing the reduce computation, and may suppress the processing performance of another computation from lowering even when the allreduce processing is executed. Moreover, the reduce computation is executed without the main storage device 3 being accessed, therefore, it is possible to suppress the access efficiency to the main storage device 3 due to the execution of the reduce computation from lowering.

The transfer controlling unit 7 (master) issues, based on the completion of the reduce computation using the data held in the buffer unit 6, a writing request to the main storage device 3 of the local node, and stores the result data of the reduce computation in the main storage device 3 ((i) of FIG. 2). Moreover, the transfer controlling unit 7 (master) issues a writing request to the information processing apparatus 1 that operates as a slave ((j) of FIG. 2). The transfer controlling unit 7 having received the writing request issues a writing request to the main storage device 3 of the local node, and stores the result data of the reduce computation that the information processing apparatus 1 that operates as a master has executed, in the main storage device 3 ((k) of FIG. 2).

Thereafter, the information processing system 100 repeatedly executes the operations illustrated in from (a) to (k) of FIG. 2. In other words, the transfer controlling unit 7 (master) issues a reading request to the information processing apparatuses 1 of the other nodes and the main storage device 3 of the local node, and read data to be used in the next reduce computation from the main storage devices 3 of all the nodes. Further, the transfer controlling unit 7 stores the read data in the buffer unit 6. The computation processing unit 5 of the information processing apparatus 1 that operates as a master executes the reduce computation using the data held in the buffer unit 6. The transfer controlling unit 7 (master) executes, based on the completion of the reduce computation, processing to store result data of the reduce computation, in the main storage devices 3 of the local node and the other nodes.

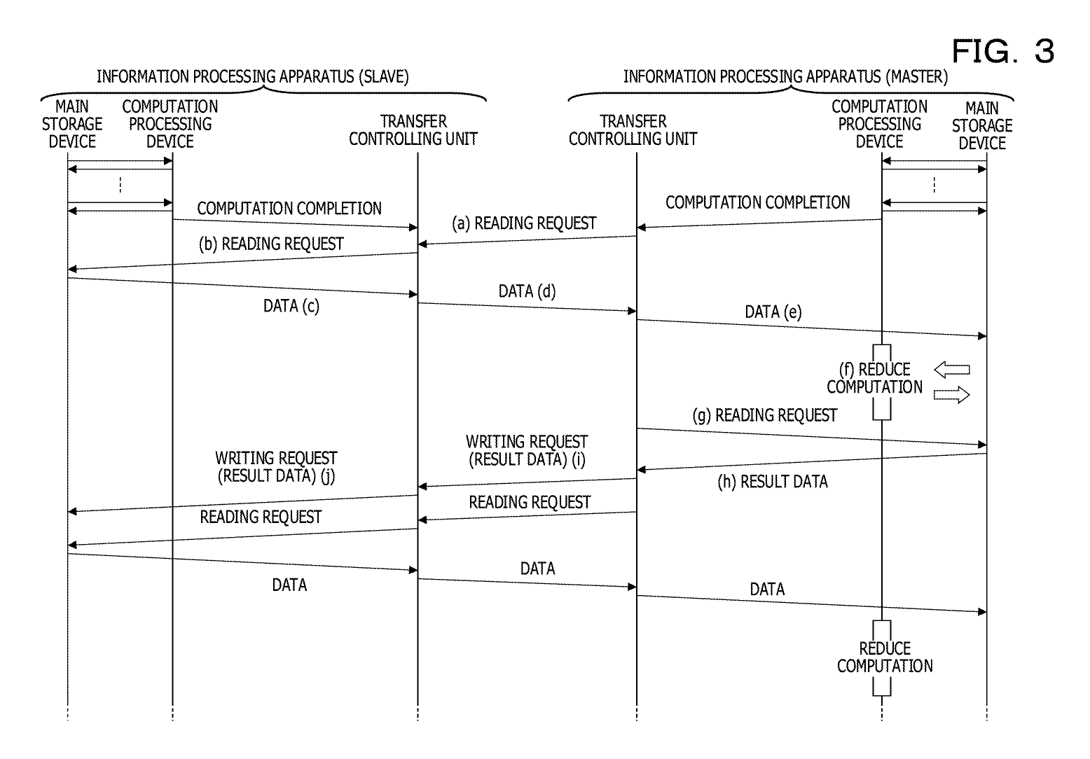

FIG. 3 illustrates one example of an operation of another information processing system different from the information processing system illustrated in FIG. 1. Detailed explanations of the operations similar to those illustrated in FIG. 2 are omitted. Respective information processing apparatuses in the information processing system that executes the operation illustrated in FIG. 3 each have a configuration similar to that of the information processing apparatus 1 illustrated in FIG. 1, except that no computation processing unit 5 and no buffer unit 6 illustrated in FIG. 1 are included. For example, each of the information processing apparatuses includes a computation processing device, a main storage device, and a control device including no computation processing unit 5 and no buffer unit 6. Each information processing apparatus executes the reduce computation by the computation processing device, using data held in the main storage device.

Similar to FIG. 2, each information processing apparatus causes the computation processing device to operate to read data from the main storage device 3, executes the computation processing such as the FMA operation, and stores the computation result in the main storage device of the local node. Based on the completion of the computations in the computation processing devices of all the information processing apparatuses, the transfer controlling unit of the information processing apparatus that operates as a master issues a reading request to the information processing apparatus that operates as a slave ((a) of FIG. 3).

The transfer controlling unit of the information processing apparatus that operates as a slave issues, when having received the reading request from the information processing apparatus that operates as a master, a reading request to the main storage device of the local node, and reads data from the main storage device ((b) and (c) of FIG. 3). Further, the transfer controlling unit outputs the data read from the main storage device to the information processing apparatus that operates as a master ((d) of FIG. 3). The transfer controlling unit of the information processing apparatus that operates as a master stores the data received from the information processing apparatus that operates as a slave, in the main storage device ((e) of FIG. 3).

The computation processing device of the information processing apparatus that operates as a master starts, after the storage of the data from the main storage device of the information processing apparatus that operates as a slave to the main storage device of the local node has been completed, the reduce computation using the data held in the main storage device ((f) of FIG. 3). The computation processing device executes the processing of reduce computation, while repeatedly executing a load of target data for the reduce computation from the main storage device and storing of result data of the reduce computation in the main storage device.

The transfer controlling unit (master) issues, based on the completion of the execution of the reduce computation, a reading request to the main storage device of the local node, and reads the result data of the reduce computation from the main storage device ((g) and (h) of FIG. 3). The transfer controlling unit (master) issues a writing request to the information processing apparatus that operates as a slave ((i) of FIG. 3). The transfer controlling unit having received the writing request issues a writing request to the main storage device of the local node, and stores the result data of the reduce computation in the main storage device ((j) of FIG. 3).

Thereafter, the information processing system repeatedly executes the operations illustrated in from (a) to (j) of FIG. 3. For example, the transfer controlling unit (master) issues a reading request to the information processing apparatus that operates as a slave, reads data to be used in the next reduce computation from the main storage device of the other node, and stores the read data in the main storage device. The computation processing device of the information processing apparatus that operates as a master executes the reduce computation using the data held in the main storage device. The transfer controlling unit (master) executes, based on the completion of the reduce computation, processing to store the result data of the reduce computation in the main storage device of the information processing apparatus that operates as a slave.

In the information processing system that executes the operation illustrated in FIG. 3, the main storage device is coupled to the transfer controlling unit via the common bus. This makes the transfer time of data to the main storage device by the transfer controlling unit data longer, compared with the transfer time of data to the buffer unit 6 by the transfer controlling unit 7 illustrated in FIG. 1. This causes the start of the reduce computation in FIG. 3 to be delayed, compared with that in FIG. 2. Moreover, the reading time of data used in the reduce computation from the main storage device also becomes longer than the reading time of data from the buffer unit 6 illustrated in FIG. 1. This makes the execution time of the reduce computation longer, compared with that in FIG. 2. In addition, the target data for the reduce computation is stored in the main storage device, therefore, compared with the information processing system 100 illustrated in FIG. 1, the memory area used for the reduce computation in the main storage device 3 increases, while the free space decreases.

The result data of the reduce computation is stored in the main storage device, therefore, the transfer of data to the information processing apparatus that operates as a slave is executed by the result data being read from the main storage device. This causes the timing for transferring the result data to the information processing apparatus that operates as a slave to be delayed, and the timing for reading target data for the next reduce computation from the information processing apparatus that operates as a slave to be delayed, compared with those in FIG. 2. In addition, the computation processing device is unable to execute another computation while executing the reduce computation, and the other devices are unable to access the main storage device while the computation processing device accesses the main storage device for the reduce computation.

As a result, the computation performance by each information processing apparatus is lowered in the information processing system that executes the operation illustrated in FIG. 3, compared with that in the information processing system 100 illustrated in FIG. 1.

In FIGS. 1 and 2, the reduce computation is executed without the computation processing device 2 being used, and is executed without the main storage device 3 being accessed. This allows the computation processing device 2 to execute another computation while the computation processing unit 5 is executing the reduce computation, and may suppress the processing performance of another computation from lowering due to the allreduce processing. The reduce computation is executed without the main storage device 3 being accessed, therefore, it is possible to suppress the access efficiency to the main storage device 3 due to the execution of the reduce computation from lowering.

The transfer time of target data for the reduce computation from the transfer controlling unit 7 to the buffer unit 6 may be made shorter, compared with the transfer time of target data from the transfer controlling unit 7 to the main storage device 3, therefore, it is possible to make the start of the reduce computation earlier, compared with that in FIG. 3. Moreover, the transfer time of target data from the buffer unit 6 to the computation processing unit 5 may be made shorter, compared with the transfer time of target data from the main storage device 3 to the computation processing device 2, therefore, it is possible to make the execution time of the reduce computation shorter, compared with that in FIG. 3.

The result data of the reduce computation is transferred, without being stored in the main storage device 3, to the main storage device 3 of the information processing apparatus 1 that operates as a slave. The result data may be transferred without going through the main storage device 3 the access latency of which is larger, compared with that of the buffer unit 6, therefore, it is possible to make the start of the transfer of data used in the reduce computation to the buffer unit 6 earlier, compared with that in FIG. 3, and start the next reduce computation early.

The data used in the reduce computation is stored in the buffer unit 6 but not in the main storage device 3, therefore, it is possible to execute the reduce computation without providing a memory area in which data used in the reduce computation is stored in the main storage device 3.

It is possible to more improve the processing performance of the information processing system 100 that executes allreduce processing, compared with that in FIG. 3.

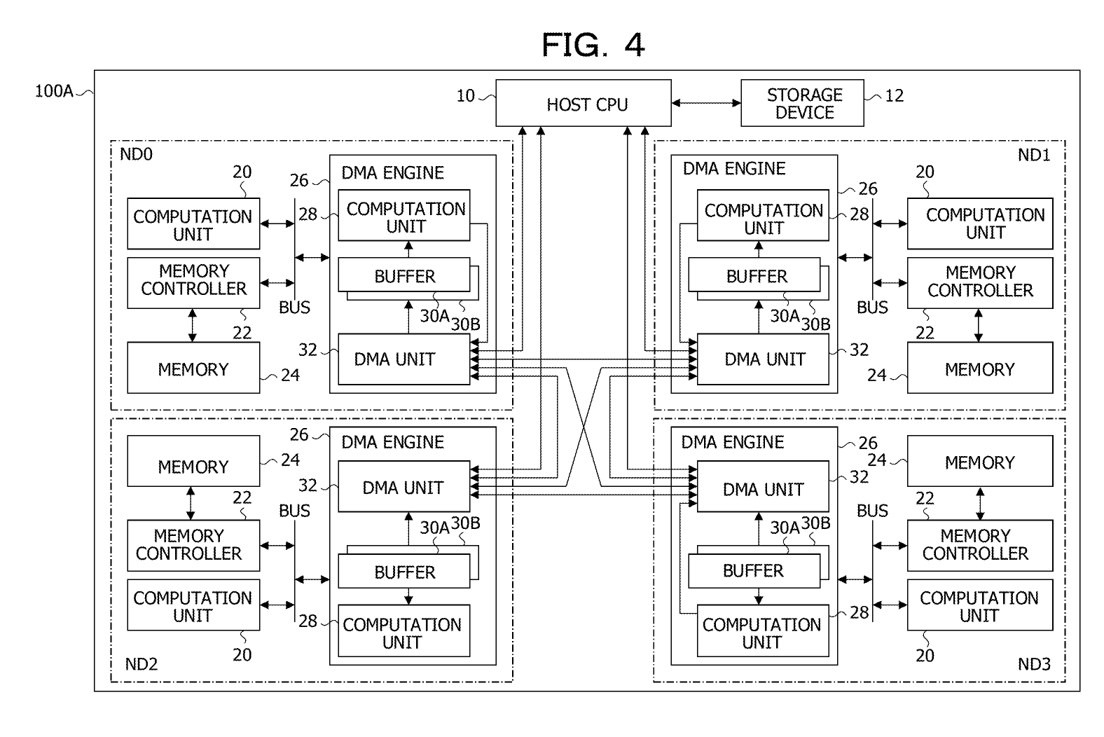

FIG. 4 illustrates one example of an information processing system, an information processing apparatus, and a method of controlling an information processing system. An information processing system 100A illustrated in FIG. 4 includes four nodes NDs (ND0, ND1, ND2, and ND3), a host CPU 10, and a storage device 12. The nodes ND0-ND3 each are one example of the information processing apparatus that processes information.

The host CPU 10 controls the overall operation of the information processing system 100A to cause, for example, the nodes ND0-ND3 to execute deep learning. The storage device 12 holds a control program that the host CPU 10 executes, and data and the like used in the learning that the nodes ND0-ND3 execute. The data used in the learning is stored in a memory 24 of each of the nodes ND0-ND3 from the storage device 12 by the control by the host CPU 10.

The nodes ND0-ND3 mutually have the same configuration, therefore, hereinafter, a configuration of the node ND0 is explained. The node ND0 includes a computation unit 20, a memory controller 22, the memory 24, and a DMA engine 26. The computation unit 20 is one example of the computation processing device, the memory 24 is one example of the main storage device 3, and the DMA engine 26 is one example of the control device that controls the transfer of data among the plurality of the nodes ND0-ND3.

The computation unit 20, the memory controller 22, and the DMA engine 26 are mutually coupled via a common bus BUS. The DMA engine 26 includes a computation unit 28, buffers 30A and 30B, and a DMA unit 32. The computation unit 28 is one example of the computation processing unit, the buffers 30A and 30B each are one example of the buffer unit, and the DMA unit 32 is one example of the transfer controlling unit. Although not particularly limited, the computation unit 20, the memory controller 22, and the DMA engine 26 are included in one semiconductor chip, and this semiconductor chip and the memory 24 are mounted on a board.

The computation unit 20 includes, for example, a plurality of FMA operating elements for floating point and the like. The computation unit 20 executes, in deep learning that the host CPU 10 executes, a computation for extracting features of data for learning (for example, image data), and a computation for calculating an error between the extracted feature data and correct answer data. The FMA operation or the like that the computation unit 20 executes is one example of the first computation.

The memory 24 stores therein data that the computation unit 20 uses and data that the computation unit 28 in the DMA engine 26 uses. For example, the memory 24 is a high bandwidth memory (HBM). Moreover, the memory 24 may be a memory module including a synchronous dynamic random access memory (SDRAM) and the like.

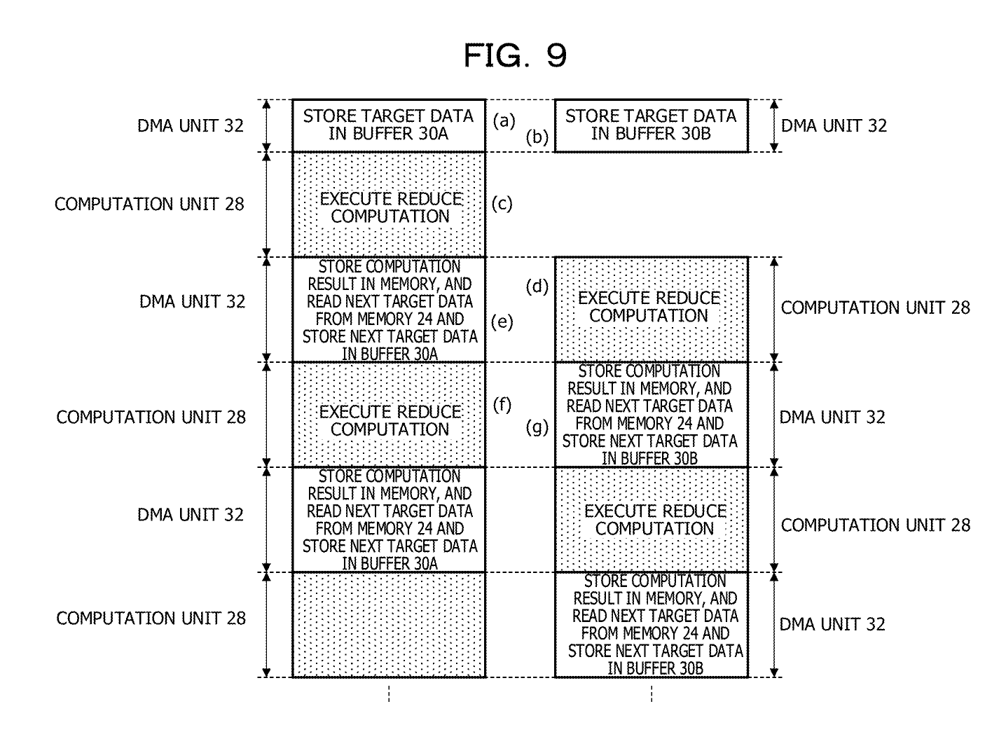

The computation unit 28 includes a plurality of computing elements such as adders and dividers for floating point. Further, the computation unit 28 executes, using data in the local node ND0 and data collected from the other nodes ND1-ND3, a computation such as averaging processing and the like. In other words, the DMA engine 26 executes reduce processing in which data collected from the plurality of the nodes NDs are bundled and processed. The reduce processing is also executed in the DMA engines 26 of the other nodes ND1-ND3, therefore, allreduce processing is executed in the entire information processing system 100A. An example of the allreduce processing is explained in from FIGS. 9 to 14.

In the following, a computation that the computation unit 28 executes for reduce processing is also referred to as a reduce computation. The reduce computation that the computation unit 28 executes is one example of the second computation. The buffers 30A and 30B respectively hold data used in the reduce computation.

The computation unit 28 executes the reduce computation by alternately using the data held in the buffers 30A and 30B. This allows data for next reduce computation to be stored in the buffer 30B during the reduce computation of the data held in the buffer 30A. In other words, data transfer is executed in the background of the reduce computation to allow the reduce computation to be continuously executed.

The access latency of the buffers 30A and 30B is smaller than the access latency of the memory 24. This allows the computation unit 28 to read data from the buffers 30A and 30B at the higher speed, compared with a case where data is read from the memory 24. Moreover, the DMA unit 32 may store the data in the buffers 30A and 30B at the higher speed, compared with a case where the data is stored in the memory 24.

The DMA unit 32 has a function to transfer data between the storage device 12 and the memory 24 of the local node ND0, via the host CPU 10. Moreover, the DMA unit 32 has a function to transfer data from the memory 24 of the local node ND0 or the memories 24 of the other nodes ND1-ND3 to the buffers 30A and 30B of the local node ND0. In addition, the DMA unit 32 has a function to transfer the result data obtained due to the reduce computation to the memory 24 of the local node ND0 or the memories 24 of the other nodes ND1-ND3. Moreover, the DMA unit 32 may have a function to transfer data held in the memory 24 of the local node ND0 to the buffers 30A and 30B of the other nodes ND1-ND3.

Each of the nodes ND0-ND3 operates as a slave that transfers target data for the computation to the other nodes NDs that execute reduce computations, and operates as a master that executes a reduce computation and transfers result data of the reduce computation to the other nodes NDs. For example, each of the nodes ND0-ND3 executes processing as a slave and processing as a master in a mixed manner. The four nodes ND0-ND3 execute in parallel the reduce computations, thereby executing allreduce processing. In the following, for easy understanding of the explanation, the operation as a master and the operation as a slave may be described in a distinguished manner in some cases.

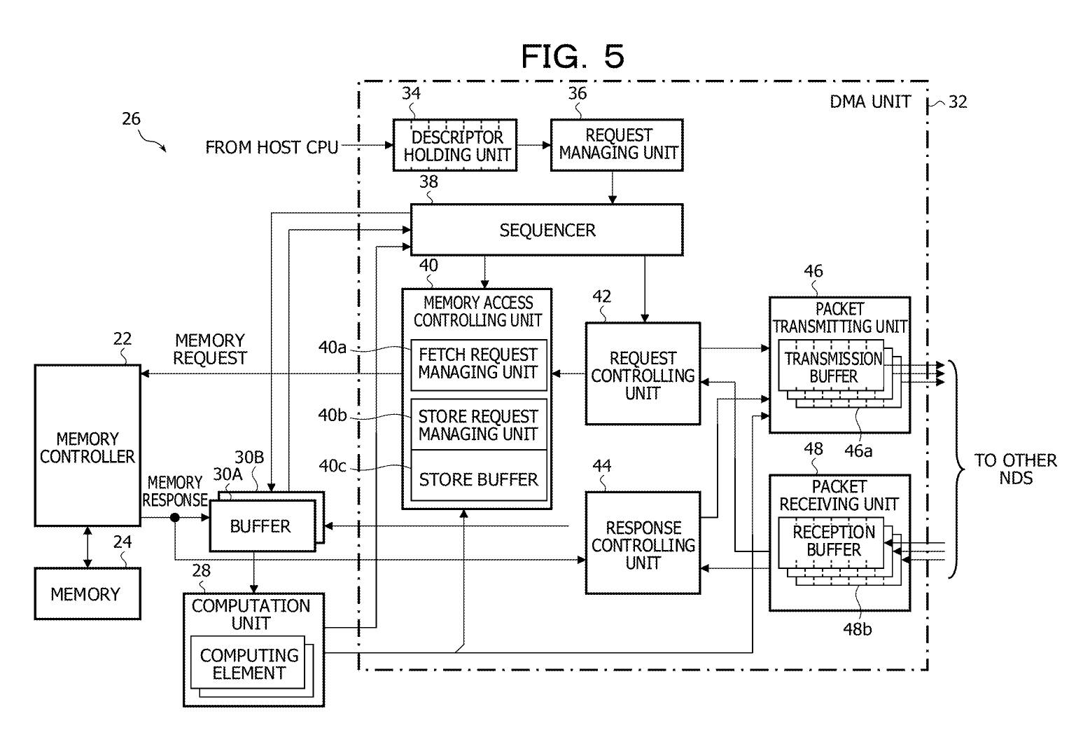

FIG. 5 illustrates one example of the DMA unit illustrated in FIG. 4. The DMA unit 32 includes a descriptor holding unit 34, a request managing unit 36, a sequencer 38, a memory access controlling unit 40, a request controlling unit 42, a response controlling unit 44, a packet transmitting unit 46, and a packet receiving unit 48.

The descriptor holding unit 34 includes a plurality of entries that hold descriptors including DMA transfer instructions to be activated in the execution of the allreduce processing. For example, the descriptor includes information to identify the other node ND that executes allreduce processing, and area information on the memory 24 in which target data for the reduce computation executed by the local node ND is held. Moreover, the descriptor includes area information on the memories 24 of the other nodes NDs in which target data for the reduce computations respectively executed by the other nodes is held. If it is possible to indirectly obtain area information on the memory 24 of the other node ND based on area information on the memory 24 of the local node ND, the area information on the memory 24 of the other node may not be included in the descriptor.

For example, area information on the memory 24 included in the descriptor includes a head address and a size of the target data (data length) of the memory area in which target data for the reduce computation is held. Moreover, when result data obtained due to the reduce computation is held in a memory area different from the memory area of the memory 24 in which the target data before the reduce computation is held, the descriptor further includes information indicating a memory area in which the result data is stored.

The descriptor stored in the descriptor holding unit 34 is held in the storage device 12 illustrated in FIG. 4. Further, in response to a transfer request packet that the DMA unit 32 issues to the host CPU 10, the descriptor is transferred from the storage device 12 to the DMA unit 32 via the host CPU 10, and stored in the descriptor holding unit 34.

For example, the DMA unit 32 transfers in advance a plurality of descriptors from the storage device 12 to the descriptor holding unit 34. Further, the DMA unit 32 transfers, every time the reduce computation on data having a predetermined size indicated by the descriptor is completed, a new descriptor from the storage device 12 to the descriptor holding unit 34. For example, the predetermined size is 16 megabyte (MB) that is maximum transfer unit of data by the DMA unit 32. Note that the maximum transfer unit of data by the DMA unit 32 is not limited to 16 MB, but the predetermined size may be smaller than the maximum transfer unit of data by the DMA unit 32.

The request managing unit 36 takes out, when the sequencer 38 is activated in order to execute the reduce computation on data having a predetermined amount, a target descriptor from the descriptor holding unit 34, and outputs the taken-out descriptor to the sequencer 38.

The sequencer 38 is activated based on the reception of the descriptor from the request managing unit 36. The sequencer 38 controls, until the reduce computation on data having a predetermined size instructed with the descriptor is completed, the transfer of data used in the reduce computation, the reduce computation, and the transfer of result data obtained due to the reduce computation. For example, it is assumed that the predetermined size instructed with the descriptor is 16 MB, and the access unit (the maximum data size of packet, which is described later) of the memory 24 is 2 kilobyte (KB). In this case, every time data of 16 MB is transferred from the storage device 12 to the memory 24 of each node ND, the reduce computation and the data transfer before and after reduce computation are executed in units of 2 KB. The access unit to the memory 24 is determined depending on the maximum data size that is transferable with packets, which is described later (maximum payload size), but is not limited to 2 KB.

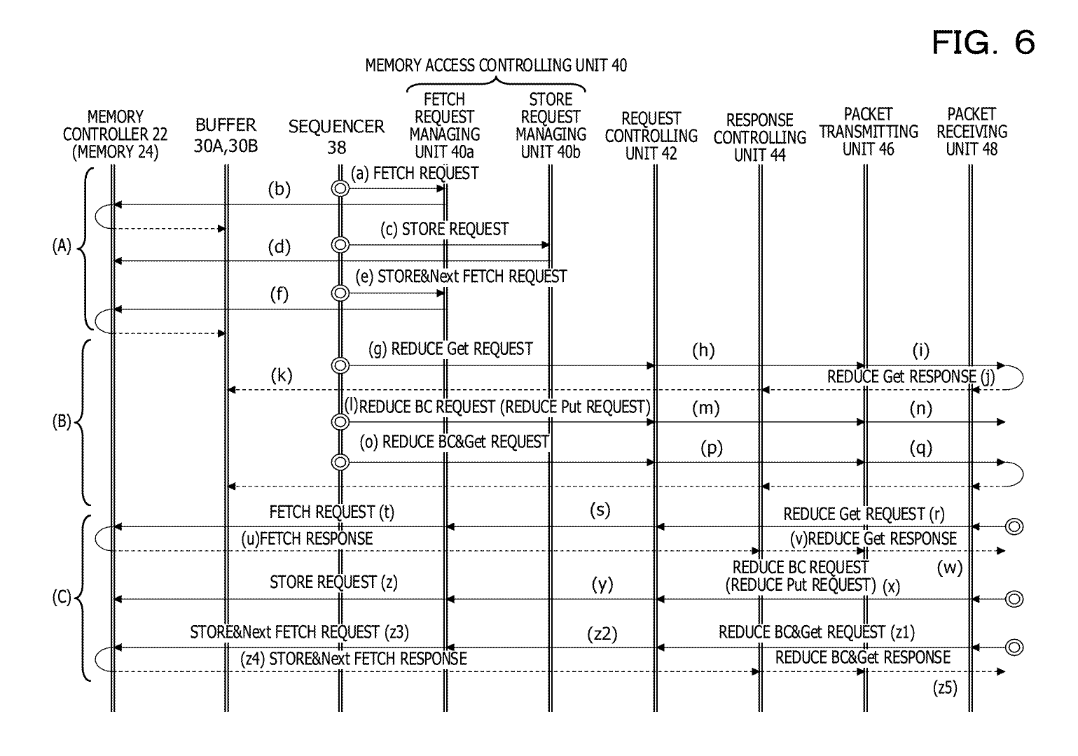

The sequencer 38 issues an access request of the memory 24 to the memory access controlling unit 40 when controlling transfer of data in the local node ND, and issues various kinds of requests to the request controlling unit 42 when controlling transfer of data from the local node ND to the other node ND. The example of control of the data transfer that the sequencer 38 executes is illustrated in FIG. 6. The sequencer 38 alternately uses the buffers 30A and 30B to cause the computation unit 28 to execute the reduce computation. Accordingly, the sequencer 38 controls and causes either one of the buffers 30A and 30B to receive data so as to match the timing when data is read from the memory 24 based on a fetch request and the like. Moreover, the sequencer 38 confirms, based on information indicating a storage status of data outputted from each of the buffers 30A and 30B, that the target data for the reduce computation has been completely stored in either one of the buffers 30A and 30B. The sequencer 38 outputs a start instruction of the reduce computation to either one of the buffers 30A and 30B in which the target data has been completely stored. Either one of the buffers 30A and 30B having received the instruction of start of the reduce computation outputs the target data for the reduce computation and a start instruction of the computation to the computation unit 28.

The computation unit 28 executes the reduce computation using the data received from either one of the buffers 30A and 30B. The computation unit 28 stores the result data of the reduce computation in a store buffer 40c and transmission buffers 46a of the packet transmitting unit 46. The computation unit 28 outputs completion information indicating the completion of the reduce computation to the sequencer 38. The sequencer 38 outputs, based on the completion information, in order to store the result data of the reduce computation in the memory 24 of the local node ND, an access request of the memory 24 to the memory access controlling unit 40. Moreover, the sequencer 38 outputs, based on the completion information, in order to store the result data of the reduce computation in the memory 24 of the other node ND, a reduce BC (broadcast) request or a reduce BC&Get request, which is described later, to the request controlling unit 42.

The memory access controlling unit 40 includes a fetch request managing unit 40a, a store request managing unit 40b, and the store buffer 40c. The store buffer 40c stores therein the result data of the reduce computation that the computation unit 28 of the local node ND has executed. An example of the operations of the fetch request managing unit 40a and the store request managing unit 40b is illustrated in FIG. 6.

The request controlling unit 42 outputs various kinds of requests received from the sequencer 38 to the packet transmitting unit 46, and outputs various kinds of requests received from the packet receiving unit 48 to the memory access controlling unit 40. The response controlling unit 44 generates a response, when receiving the data having received from the memory 24 of the local node ND in response to an access request of the memory 24 of the local node ND that the other node ND has issued, and outputs the response to the packet transmitting unit 46. The response controlling unit 44 stores, when receiving data included in the response that the other node ND has issued from the packet receiving unit 48, the received data in either one of the buffers 30A and 30B. The response controlling unit 44 outputs, when receiving a response corresponding to the various kinds of requests that the local node ND has issued to the other node ND from the packet receiving unit 48, information indicating that the response has received from the other node ND, to the sequencer 38.

The packet transmitting unit 46 includes the plurality of the transmission buffers 46a in which packets to be transmitted to the other nodes NDs by respectively being corresponded to the other nodes NDs are stored. Each the transmission buffers 46a includes a plurality of entries in which a plurality of packets are stored. The packet transmitting unit 46 generates packets, based on the various kinds of requests and the information received from the request controlling unit 42 and the response controlling unit 44, and stores the generated packets in the transmission buffers 46a for every destination. The packet transmitting unit 46 successively issues the packets stored in the transmission buffers 46a.

The packet receiving unit 48 includes a plurality of reception buffers 48a in which the packets received from the other nodes NDs by respectively being corresponded to the other nodes NDs are stored. Each reception buffer 48a includes a plurality of entries in which a plurality of packets are stored. The packet receiving unit 48 outputs, based on the request packet stored in the reception buffers 48a, various kinds of requests to the request controlling unit 42, and outputs, based on the response packets stored in the reception buffers 48a, various kinds of responses to the response controlling unit 44.

The memory controller 22 issues, based on a fetch request packet from the memory access controlling unit 40, a memory access request (read) to the memory 24. The memory controller 22 issues, based on a store request packet from the memory access controlling unit 40, a memory access request (write) to the memory 24. The memory access request is repeatedly issued, for example, until data of 2 KB is read or written.

FIG. 6 illustrates one example of an operation of the DMA unit illustrated in FIG. 5. (A) of FIG. 6 illustrates an example of an operation when a transfer request for data is issued to the local node. (B) of FIG. 6 illustrates an example of an operation when a transfer request for data is issued to the other node. (C) of FIG. 6 illustrates an example of an operation when a transfer request for data is issued from the other node. A dashed-line arrow indicates the transfer of data. For example, the memory access controlling unit 40 outputs an access request of the memory controller 22 in the form of packets, and the packet transmitting unit 46 outputs various kinds of requests and various kinds of requests in the form of packets, to the other nodes NDs.

In (A) of FIG. 6, when data is read from the memory 24 of the local node ND and is stored in either one of the buffers 30A and 30B, the sequencer 38 outputs a fetch request to the fetch request managing unit 40a ((a) of FIG. 6). When receiving the fetch request from the sequencer 38, the fetch request managing unit 40a generates and issues a fetch request packet to the memory controller 22 ((b) of FIG. 6). The memory controller 22 accesses the memory 24 based on the fetch request packet. The data read from the memory 24 is stored in the buffers 30A and 30B.

When result data of the reduce computation and the like is written in the memory 24 of the local node ND, the sequencer 38 outputs a store request to the store request managing unit 40b ((c) of FIG. 6). When receiving the store request from the sequencer 38, the store request managing unit 40b generates and issues a store request packet including the data stored in the store buffer 40c to the memory controller 22 ((d) of FIG. 6). The memory controller 22 accesses the memory 24 based on the store request packet, and writes the data in the memory 24.

When data to be used in the next reduce computation is read from the memory 24 subsequent to the writing of the result data of the reduce computation in the memory 24 of the local node ND, the sequencer 38 outputs a store&Next fetch request to the fetch request managing unit 40a ((e) of FIG. 6). For example, when receiving the store&Next fetch request from the sequencer 38, the fetch request managing unit 40a issues a store&Next fetch request packet to the memory controller 22 ((f) of FIG. 6).

After writing the data in the memory 24 based on the store&Next fetch request packet, the memory controller 22 reads data to be used in the next reduce computation from the memory 24 and outputs the data. The data read from the memory 24 is stored in the buffers 30A and 30B. The store&Next fetch request packet may be issued from the store request managing unit 40b. For example, the result data of the reduce computation is overwritten in a memory area in which original data used in the reduce computation is held, in the memory 24. The head address of the memory area in which target data for the next reduce computation is held is an address next to the last address in the memory area in which the result data of the reduce computation is overwritten.

For example, a fetch response packet is issued from the memory controller 22 based on the fetch request packet, and a store response packet is issued from the memory controller 22 based on the store request packet. Based on the store&Next fetch request packet, a store&Next fetch response packet, which is not illustrated, is issued from the memory controller 22.

In (B) of FIG. 6, when data is read from the memory 24 of the other node ND, and the read data is stored in either one of the buffers 30A and 30B of the local node ND, the sequencer 38 outputs a reduce Get request to the request controlling unit 42 ((g) of FIG. 6). When receiving the reduce Get request from the sequencer 38, the request controlling unit 42 outputs the received reduce Get request to the packet transmitting unit 46 ((h) of FIG. 6). The packet transmitting unit 46 generates, based on the reduce Get request from the request controlling unit 42, a reduce Get request packet, and outputs the generated reduce Get request packet to the other node ND ((i) of FIG. 6). The other node ND having received the reduce Get request packet executes operations illustrated in (r) to (w) of FIG. 6, which are described later.

The packet receiving unit 48 outputs, based on the reception of a reduce Get response packet (data) from the other node ND, a reduce Get response to the response controlling unit 44 ((j) of FIG. 6). The response controlling unit 44 stores data included in the reduce Get response packet from the other node ND in either one of the buffers 30A and 30B ((k) of FIG. 6). The sequencer 38 determines whether the buffer 30A or 30B stores therein data when issuing the reduce Get request, that is an origin of the reduce Get response packet.

When result data of the reduce computation stored in the memory 24 of the local node ND is transferred to the other node ND, the sequencer 38 outputs a reduce BC request (or reduce Put request) to the request controlling unit 42 ((I) of FIG. 6). The reduce BC request is used when common data is stored in the memories 24 of a plurality of the other nodes NDs. When receiving the reduce BC request (or reduce Put request) from the sequencer 38, the request controlling unit 42 outputs the received reduce BC request (or reduce Put request) to the packet transmitting unit 46 ((m) of FIG. 6).

The packet transmitting unit 46 issues a reduce BC request packet to the other node ND based on the reduce BC request from the request controlling unit 42, and issues a reduce Put request packet to the other node ND based on the reduce Put request from the request controlling unit 42 ((n) of FIG. 6). Further, when the reduce BC request or the reduce Put request is issued to the other node ND, data to be stored in the other node ND is stored in advance in the transmission buffer 46a. The other node ND received the reduce BC request or the reduce Put request executes operations illustrated in (x) to (z) of FIG. 6, which are described later.

When target data for the next reduce computation is read from the other node ND subsequent to the writing of the result data of the reduce computation in the memory 24 of the other node ND, the sequencer 38 outputs a reduce BC&Get request to the request controlling unit 42 ((o) of FIG. 6). When receiving the reduce BC&Get request from the sequencer 38, the request controlling unit 42 outputs the received reduce BC&Get request to the packet transmitting unit 46 ((p) of FIG. 6). The packet transmitting unit 46 generates, based on the reduce BC&Get request from the request controlling unit 42, a reduce BC&Get request packet, and outputs the generated reduce BC&Get request packet to the other node ND ((q) of FIG. 6). The other node ND having received the reduce BC&Get request packet executes operations illustrated in (z1) to (z4) of FIG. 6. The operation of the DMA unit 32 when having received a reduce BC&Get response packet corresponding to the reduce BC&Get request from the other node ND is similar to the operation based on the reduce Get response packet.

In (C) of FIG. 6, when having received a reduce Get request packet from the other node ND, the packet receiving unit 48 outputs a reduce Get request to the request controlling unit 42 ((r) of FIG. 6). The request controlling unit 42 outputs the reduce Get request to the fetch request managing unit 40a ((s) of FIG. 6). When receiving the reduce Get request from the request controlling unit 42, the fetch request managing unit 40a generates and issues a fetch request packet to the memory controller 22 ((t) of FIG. 6). The memory controller 22 reads data from the memory 24 based on the fetch request packet. The data read from the memory 24 is outputted, as a fetch response, to the response controlling unit 44 ((u) of FIG. 6). The response controlling unit 44 outputs, based on the fetch response, a reduce Get response to the packet transmitting unit 46 ((v) of FIG. 6). The packet transmitting unit 46 generates a reduce Get response packet, based on the reduce Get response from the response controlling unit 44, and outputs the reduce Get response packet to the node ND that is an issue source of the reduce Get request packet ((w) of FIG. 6).

When receiving the reduce BC request packet (or the reduce Put request packet) from the other node ND, the packet receiving unit 48 outputs a reduce BC request (or a reduce Put request) to the request controlling unit 42 ((x) of FIG. 6). The request controlling unit 42 outputs the reduce BC request (or the reduce Put request) to the fetch request managing unit 40a ((y) of FIG. 6). The fetch request managing unit 40a generates a store request packet based on the reduce BC request (or the reduce Put request) from the request controlling unit 42, and issues the store request packet to the memory controller 22 ((z) of FIG. 6). The memory controller 22 writes, based on the store request packet, data included in the reduce BC request packet (or the reduce Put request packet) in the memory 24. Note that, actually, based on the reduce BC request packet (or the reduce Put request packet), a reduce BC response packet (or a reduce Put response packet), which is not illustrated, is issued from the memory controller 22.

When receiving a reduce BC&Get request packet from the other node ND, the packet receiving unit 48 outputs the reduce BC&Get request to the request controlling unit 42 ((z1) of FIG. 6). The request controlling unit 42 outputs the reduce BC&Get request to the fetch request managing unit 40a ((z2) of FIG. 6). When receiving the reduce BC&Get request from the request controlling unit 42, the fetch request managing unit 40a generates a store&Next fetch request packet, and issues the store&Next fetch request packet to the memory controller 22 ((z3) of FIG. 6). After having written the data in the memory 24 based on the store&Next fetch request packet, the memory controller 22 reads data to be used in the next reduce computation from the memory 24, and outputs the data as a store&Next fetch response packet ((z4) of FIG. 6). When a store&Next fetch request has been issued from the other node ND, the data read from the memory 24 is outputted, as a store&Next fetch response packet, to the response controlling unit 44. The response controlling unit 44 outputs the store&Next fetch response packet to the packet transmitting unit 46. The packet transmitting unit 46 issues a reduce BC&Get response packet to the node ND that is an issue source of the reduce BC&Get request packet ((z5) of FIG. 6).

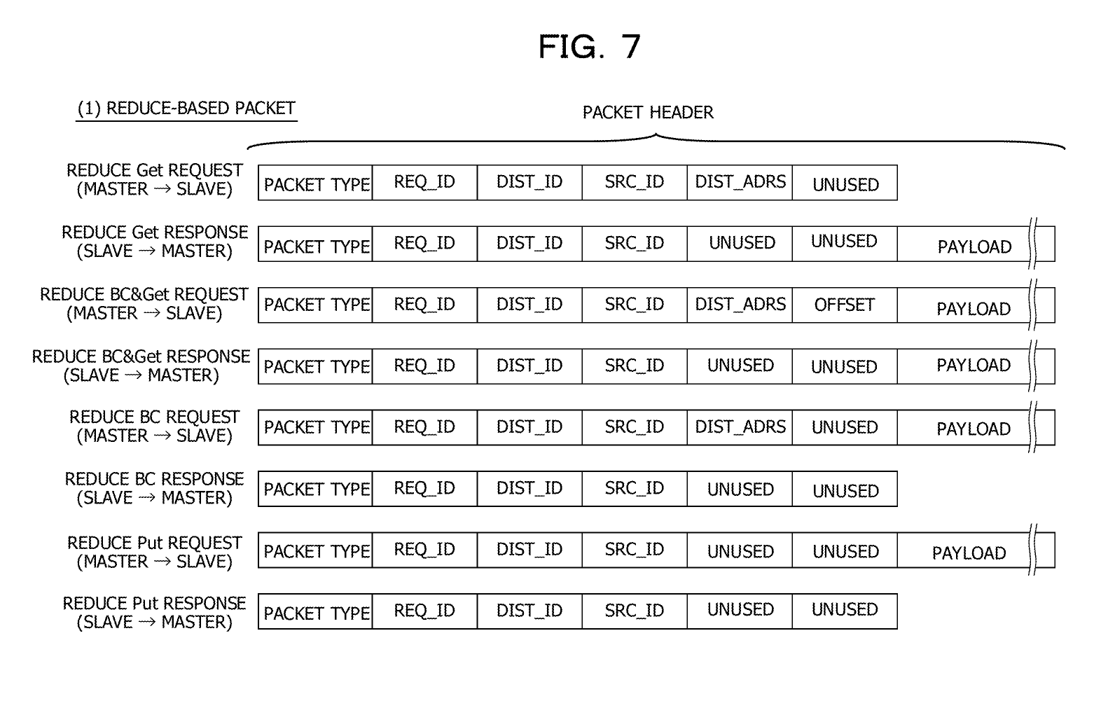

FIG. 7 illustrates one example of formats of packets used in the information processing system illustrated in FIG. 4. The reduce-based packets illustrated in FIG. 7 include a packet for reading or writing data with respect to the buffers 30A and 30B, and a packet for storing result data of the reduce computation in the memory 24.

In FIG. 7, in the column of packet type, information identifying a request packet or a response packet is stored. In the column of REQ_ID of a request packet, the number (sequence number or the like) that an issue source of the request packet has allocated for each packet is stored. In the column of REQ_ID of a response packet, the number same as the number stored in the column of REQ_ID of the corresponding request packet is stored.

In the column of DIST_ID, the number for identifying a node ND that is a destination of the packet is stored, and in the column of SRC_ID, the number for identifying a node ND that issues the packet is stored. For example, in the column of DIST_ID of the response packet, SRC_ID of the corresponding request packet is stored, and in the column of SRC_ID of the response packet, DIST_ID of the corresponding request packet is stored.

In the column of DIST_ADRS, the head address of a memory area from and in which data is read and written, in the memory 24, is stored. For example, in the column of DIST_ADRS of the reduce Get request packet, the head address of a memory area from which data is read in the memory 24 is stored. In the columns of DIST_ADRS of the reduce BC&Get request packet and the reduce BC request packet, the head address of a memory area in which data is written, in the memory 24, is stored. Note that “BC” included in the name of the packet indicates broadcast in which common data is transferred to a plurality of nodes NDs.

In the column of payload, data is stored. For example, in the column of payload of the reduce BC&Get request packet, data (result data of the reduce computation) that is written in the memory 24 of a slave is stored. In the columns of payload of the reduce Get response packet and the reduce BC&Get response packet, data that has been read from the memory 24 of a slave and is used in the reduce computation is stored. For example, in the column of payload of the packet illustrated in FIG. 7, data of 2 KB is stored.

In the column of offset of the reduce BC&Get request packet, a relative value from the address stored in the column of DISTADRS is stored. The slave having received the reduce BC&Get request packet sequentially reads data from a memory area of the memory 24 indicated by an address in which the relative value stored in the column of offset is added to an address stored in the column of DIST_ADRS. For example, in the column of offset, an address value indicating the range of the address corresponding to a memory area in which data of “2 KB” is held is stored. This causes the slave to read data to be transmitted to a master from a next area of the memory area in which data stored in the column of payload is stored, in the memory 24. When an address value corresponding to data of “2 KB” is fixed as the offset, the column of offset may be set as unused.

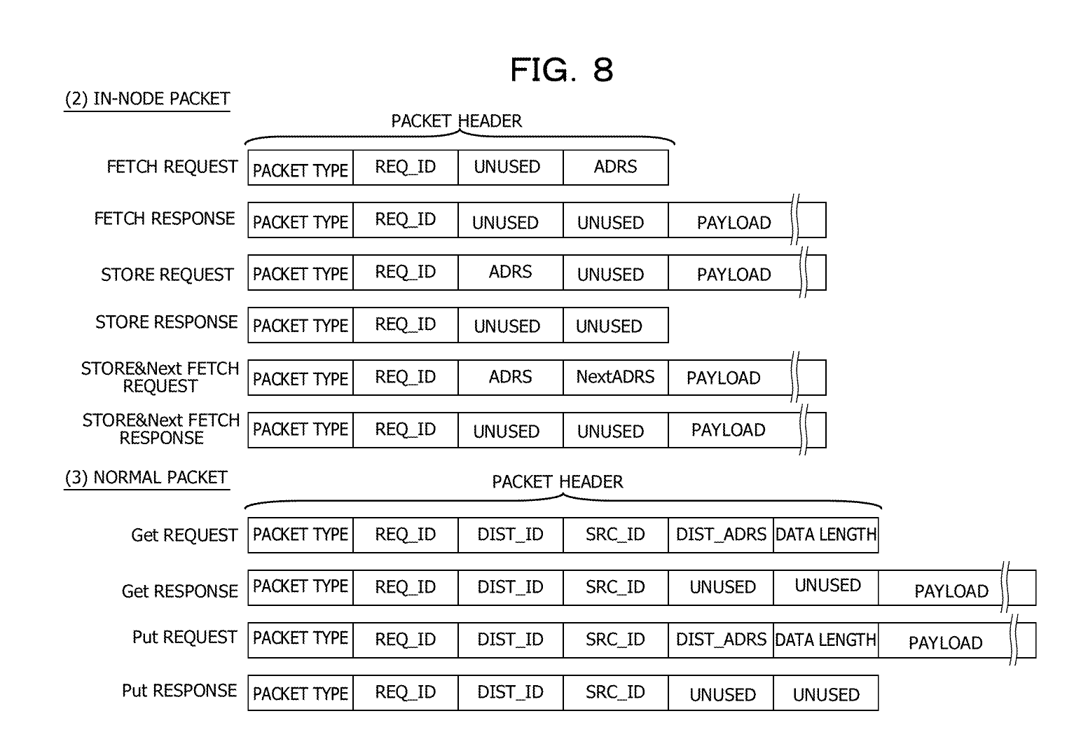

FIG. 8 illustrates one example (continued from FIG. 7) of formats of packets used in the information processing system illustrated in FIG. 4. The columns of packet type, REQ_ID, DIST_ID, SRC_ID, DIST_ADRS, and payload respectively have the same usage purposes as those of FIG. 7. In-node packets illustrated in FIG. 8 include a packet in which the local node ND reads and writes data from and in the memory 24 of the local node ND. The normal packet illustrated in FIG. 8 is used, for example, when data is transferred between the memories 24 of the two nodes NDs.

As for the in-node packet, in the column of ADRS of the fetch request packet, the head address of a memory area of the memory 24 from which data is read is stored. In the columns of ADRS of the store request packet and the store&Next fetch request packet, the head address of a memory area of the memory 24 in which data of the payload is stored is stored. In the column of NextADRS of the store&Next fetch request packet, the head address of a memory area of the memory 24 from which data is read is stored. The address to be stored in the column of NextADRS is calculated, for example, by the memory access controlling unit 40 illustrated in FIG. 5.

As for the normal packet, in the column of DIST_ADRS of the Get request packet, the head address of a memory area from which data is read in the memory 24 is stored. In the column of data length of the Get request packet, the size of data to be read from the memory 24 is stored. In the column of DIST_ADRS of the Put request packet, the head address of a memory area in which data is written, in the memory 24, is stored. In the column of data length of the Put request packet, the size of data that is written in the memory 24 is stored. Note that although not particularly limited, a packet similar to the normal packet in FIG. 8 is used in data transfer between the host CPU 10 and each of the nodes ND0-ND3 illustrated in FIG. 4.

FIG. 9 illustrates one example of an operation of the DMA engine illustrated in FIG. 4. For example, the operation illustrated in FIG. 9 executed in parallel in each node ND every time target data of 16 MB for the reduce computation is transferred to each node ND from the storage device 12.

The DMA unit 32 stores target data for the reduce computation (for example, 2 KB) held in the memory 24 of the local node ND in each of the buffers 30A and 30B of the local node ND. Moreover, the DMA unit 32 stores target data for the reduce computation (for example, 2 KB) held in each of the memories 24 of the other three nodes NDs in each of the buffers 30A and 30B of the local node ND ((a) and (b) of FIG. 9).

Data of total 8 KB is stored in each of the buffers 30A and 30B, thus, the buffers 30A and 30B each having a storage capacity of 8 KB or more are provided in each node ND. For example, the storage capacity of each of the buffers 30A and 30B is determined based on the maximum size of data stored in the payload of each packet illustrated in FIGS. 7 and 8.

For example, the storage capacity of each of the buffers 30A and 30B is set to a value in which the maximum size (2 KB) of data transferable with one packet is multiplied by the number (four) of nodes NDs that execute allreduce processing. The storage capacity of each of the buffers 30A and 30B is set based on the size of the payload of the packet to accordingly allow the minimum scale of each of the buffers 30A and 30B. As a result, it is possible to achieve the minimum increase in the circuit scale of the DMA engine 26 even when the buffers 30A and 30B are provided in the DMA engine 26.

The computation unit 28 successively executes the reduce computations using the data stored in the buffer 30A, and overwrites result data obtained due to the reduce computation in the buffer 30A ((c) of FIG. 9). The result data is overwritten in the memory area of the buffer 30A that holds data used in the reduce computation to accordingly allow the minimum storage capacity of the buffer 30A that is used in the reduce processing. The result data may be stored in a free space of the buffer 30A. In this case, the buffers 30A and 30B each having a storage capacity of 10 KB or more are provided.

The computation unit 28 successively executes the reduce computations using the data stored in the buffer 30B, and overwrites result data obtained due to the reduce computation in the buffer 30B ((d) of FIG. 9). The DMA unit 32 stores the result data held in the buffer 30A in the memory 24 of the local node ND, and reads next target data for which the reduce computation is executed from the memory 24 of the local node ND and stores the next target data in the buffer 30A. Moreover, the DMA unit 32 stores the result data held in the buffer 30A in the memory 24 of the other node ND, and reads next target data for which the reduce computation is executed from the memory 24 of the other node ND and stores the next target data in the buffer 30A ((e) of FIG. 9). The transfer of data between the memories 24 of the local node ND and the other nodes ND, and the buffer 30A by the DMA unit 32 is executed in the background of the reduce computation that the computation unit 28 is executing.

The computation unit 28 successively executes the reduce computations using the data stored in the buffer 30A, and overwrites result data obtained due to the reduce computation in the buffer 30A ((f) of FIG. 9). The DMA unit 32 stores, in the background of the reduce computation that the computation unit 28 is executing, the result data stored in the buffer 30B in the memory 24, reads next target data for which the reduce computation is executed from the memory 24 and stores the next target data in the buffer 30B ((g) of FIG. 9).

Thereafter, the computation unit 28 alternately switches the buffers 30A and 30B from which data is read and executes the reduce computation, and the DMA unit 32 alternately switches the buffers 30A and 30B to which data is transferred. The reduce computation and the data transfer with respect to the memory 24 are repeatedly executed alternately using the buffers 30A and 30B, thereby executing the reduce processing of data of 16 MB stored in the memory 24. In the example illustrated in FIG. 9, the buffers 30A and 30B are used to allow the reduce computation and the data transfer with respect to the memory 24 to be executed in parallel. As a result, it is possible to continuously and continually execute the reduce computation, and shorten the execution time of the reduce processing, compared with the case where the reduce computation and the data transfer with respect to the memory 24 are alternately executed.

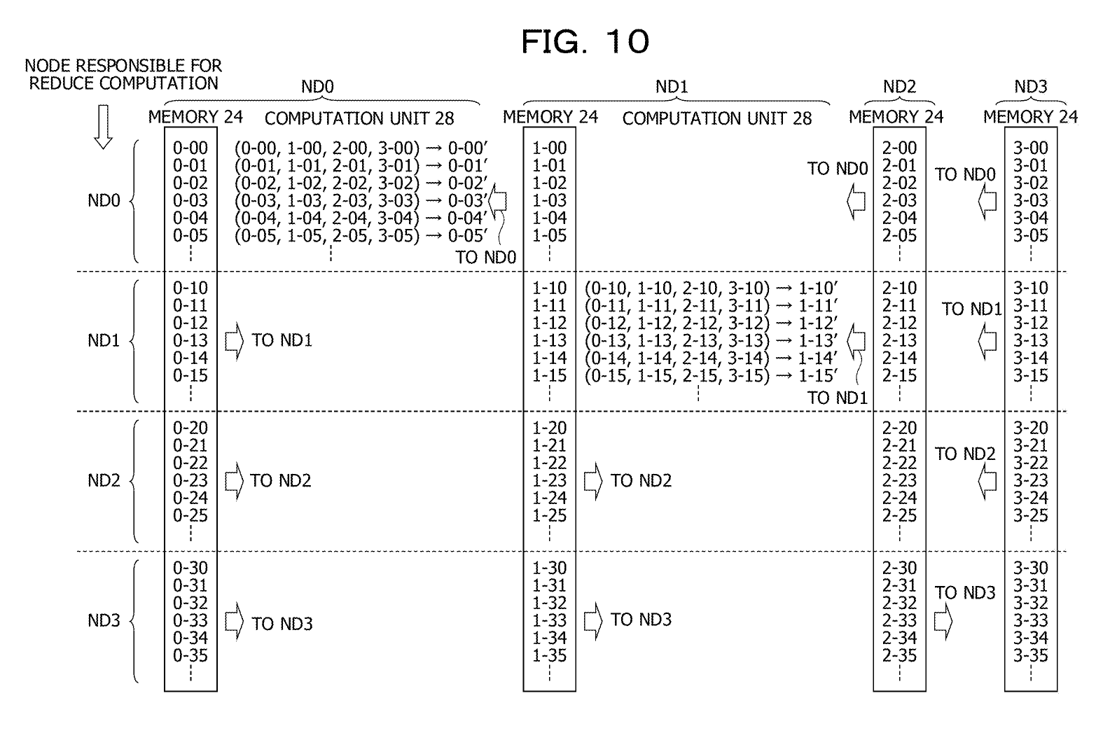

FIG. 10 illustrates one example of a relation between data stored in the memories of the respective nodes NDs illustrated in FIG. 4 and the node ND responsible for the reduce computation. In the memory 24 of the node ND0, data that is used in the reduce computations executed in the local node ND0 and the other nodes ND1-ND3 is held. In the memory 24 of the node ND1, data that is used in the reduce computations executed in the local node ND1 and the other nodes ND0, ND2, and ND3 is held. Similarly, also in the memory 24 of each of the nodes ND2 and ND3, data that is used in the reduce computations executed in the four nodes ND0-ND3 is held.

In the target data for the reduce computation held in the memory 24 illustrated in FIG. 10, the head numeric character indicates the number of the node ND the memory 24 of which holds data. In the two-digit numeric character subsequent to “-”, the upper-level value indicates the number of the node ND that executes the reduce computation, the lower-level value indicates the number of data. As illustrated in FIG. 10, out of the data held in the memory 24, data having an upper-level value subsequent to “-” of “0” is collected to the node ND0, and data having an upper-level value subsequent to “-” of “1” is collected to the node ND1. Data having an upper-level value subsequent to “-” of “2” is collected to the node ND2, and data having an upper-level value subsequent to “-” of “3” is collected to the node ND3.

Each of the nodes ND0-ND3 executes the reduce computation for every collected four pieces of data. For example, the node ND0 executes the reduce computation for data “0-00”, “1-00”, “2-00”, and “3-00”, and calculates result data “0-00′”. Moreover, the node ND0 executes the reduce computation for data “0-01”, “1-01”, “2-01”, and “3-01”, and calculates result data “0-01′”. The node ND1 executes the reduce computation for data “0-10”, “1-10”, “2-10”, and “3-10”, and calculates result data “0-10′”. The node ND1 executes the reduce computation for data “0-11”, “1-11”, “2-11”, and “3-11”, and calculates result data “0-11′”.

Although not illustrated in FIG. 10, the result data that each of the nodes ND0-ND3 has calculated is distributed to all the nodes ND0-ND3. For example, the result data “0-00′” and “0-01′” that the node ND0 has calculated is stored in the memory 24 of the local node ND0 and in each of the memories 24 of the other nodes ND1-ND3. The result data “0-10′” and “0-11′” that the node ND1 has calculated is stored in the memory 24 of the local node ND1 and in each of the memories 24 of the other nodes ND0, ND2, and ND3.

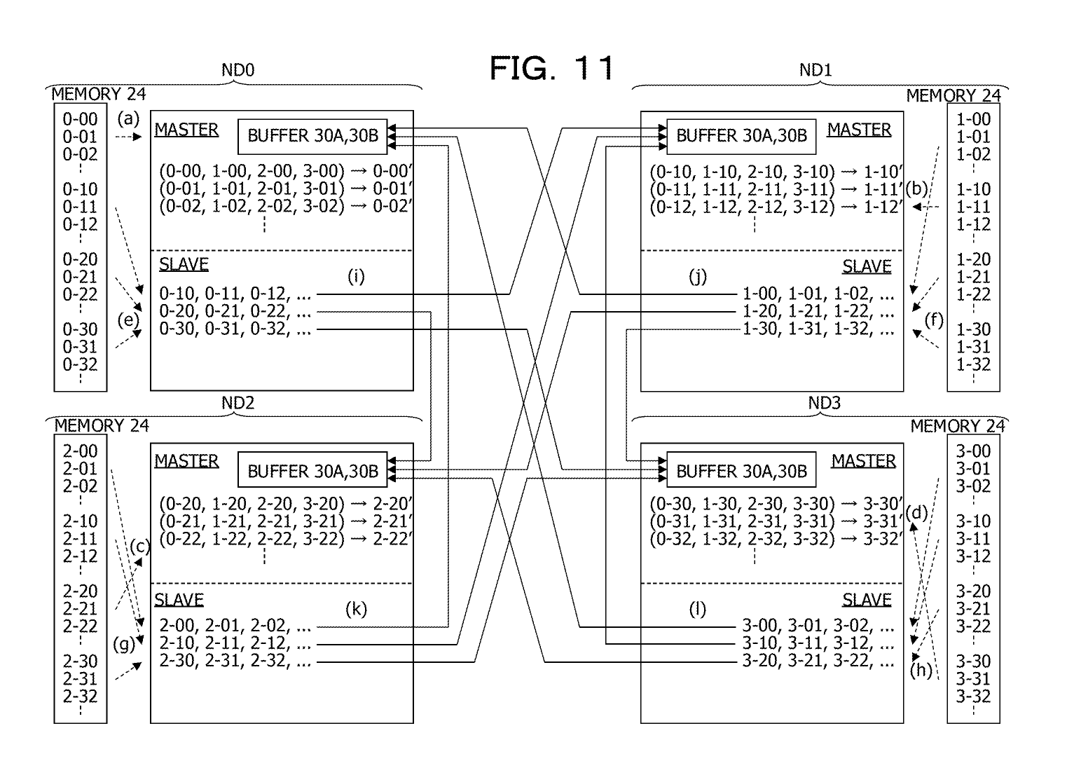

FIG. 11 illustrates one example of an operation in which the respective nodes NDs collect data, and execute in parallel the reduce computations, in the information processing system illustrated in FIG. 4. In FIG. 11, the computation unit 28 illustrated in FIG. 4 operates as a master, and the DMA unit 32 illustrated in FIG. 4 operates as a master or a slave.

In each node ND, the DMA unit 32 that operates as a master reads target data for the reduce computation executed by the local node ND from the memory 24, and stores the target data in the buffer 30A (or 30B) of the local node ND ((a), (b), (c), and (d) of FIG. 11). Moreover, in each node ND, the DMA unit 32 operates as a slave reads target data for the reduce computations executed by the other nodes NDs from the memory 24 of the local node ND ((e), (f), (g), and (h) of FIG. 11).

The DMA unit 32 operates as a slave transfers the data read from the memory 24 to the buffer 30A (or 30B) of each of the other nodes NDs ((i), (j), (k), and (I) of FIG. 11). For example, the data amounts that the nodes ND0-ND3 respectively transfer to the other nodes NDs are equal to one another. Further, in each node ND, the computation unit 28 that operates as a master executes in parallel the reduce computation using the data stored in the buffer 30A (or 30B), and calculates result data.

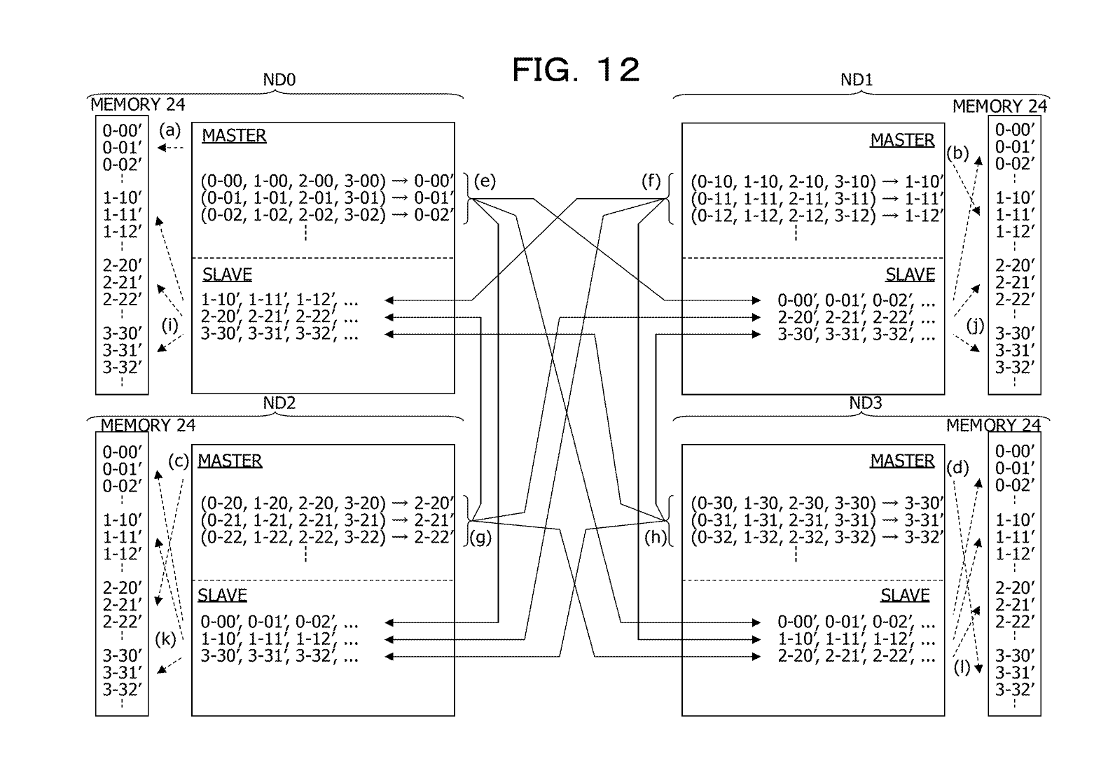

FIG. 12 illustrates one example of an operation of distributing the result data of the reduce computations that the respective nodes have executed in parallel in FIG. 9. In each node ND, the DMA unit 32 that operates as a master stores result data calculated due to the reduce computation in the memory 24 of the local node ND ((a), (b), (c), and (d) of FIG. 12).

In each node ND, the DMA unit 32 operates as a slave transfers result data calculated due to the reduce computation to the other nodes NDs ((e), (f), (g), and (h) of FIG. 12). The other nodes NDs respectively stores the received result data in the memories 24 ((i), (j), (k), and (I) of FIG. 12). In other words, the result data calculated by the computation unit 28 of each node ND is distributed to the local node ND and the other nodes NDs. For example, the data amounts that the nodes ND0-ND3 respectively transfer to the other nodes NDs are equal to one another.

The result data is overwritten in a memory area in which the target data for the reduce computation is held, in the memory 24. Note that the result data may be stored in an area different from the memory area in which the target data for the reduce computation by the local node ND is held, in the memory 24.

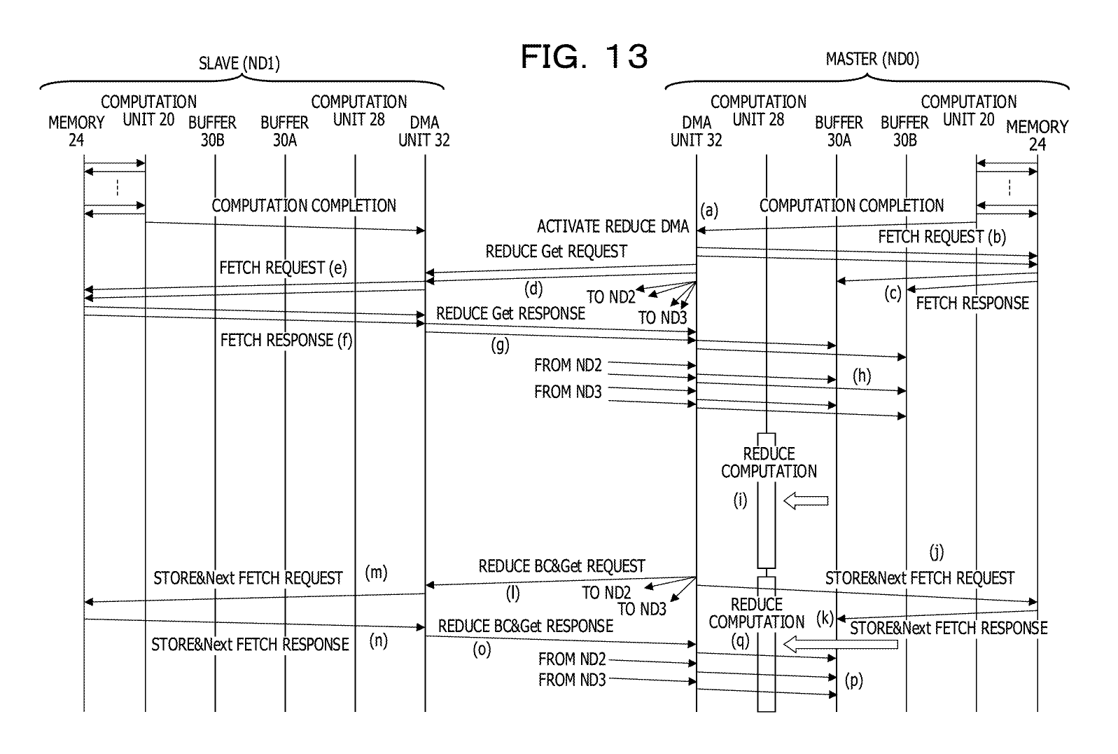

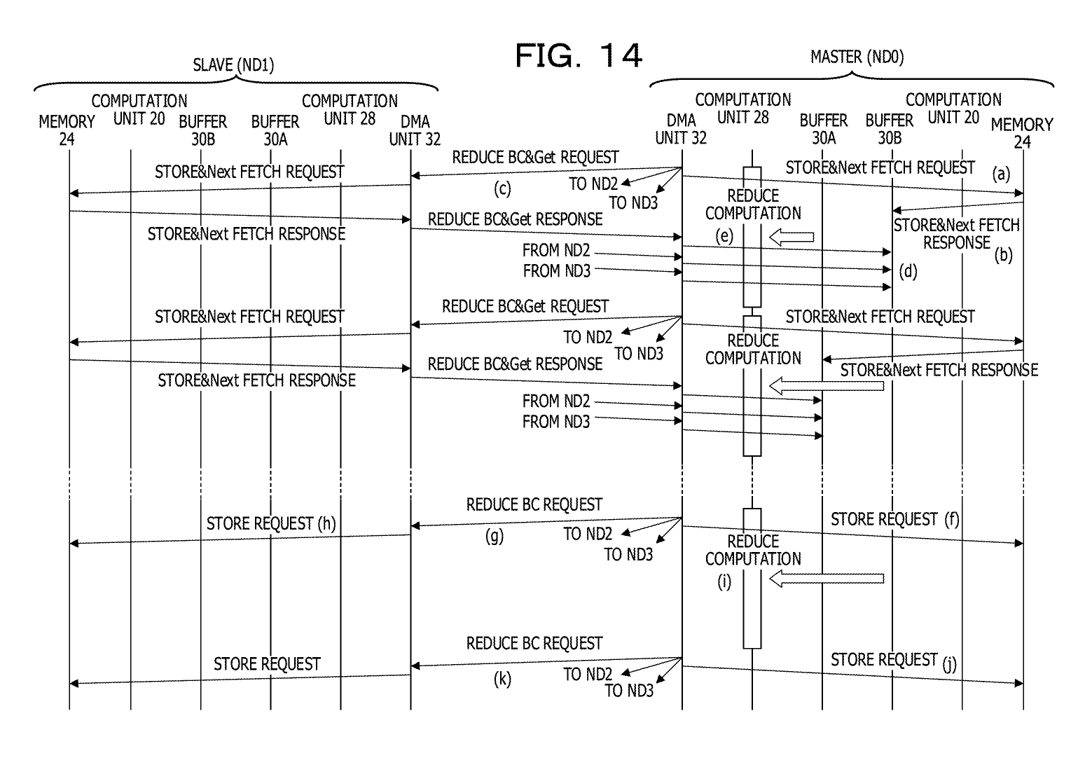

FIGS. 13 and 14 illustrate one example of an operation of the information processing system illustrated in FIG. 4. Each of the nodes ND0-ND3 executes in parallel the operation as a master and the operation as a slave illustrated in FIGS. 13 and 14. For example, as illustrated in FIGS. 11 and 12, the operation as a master and the operation as a slave are executed in each of all the nodes ND0-ND3. FIGS. 13 and 14 illustrate, for easy understanding of the explanation, the operation as a master by the node ND0 and the operation as a slave by the node ND1.

The nodes ND0-ND3 each repeat such processing of causing the computation unit 20 to operate, executing in parallel the computation processing such as the FMA operation using data held in the memory 24, and storing the computation result in the memory 24. The result of the computation (“0-00”, “0-01”, and others illustrated in FIG. 11) by the computation unit 20 is stored in the memory 24, as data to be used in the reduce computation.

The nodes ND0-ND3 wait so as to match the completions of the computation processing through the barrier synchronization and the like. The DMA unit 32 of the node ND0 activates, based on the completion of the computation processing by the computation units 20 of the local node ND0 and the other nodes ND1-ND3, DMA processing (reduce DMA) in order to execute the reduce computation ((a) of FIG. 13).

The DMA unit 32 of the node ND0 issues a fetch request in order to read data used in the reduce computation from the memory 24 of the local node ((b) of FIG. 13). Before the execution of the reduce computation is started, invalid data such as result data of the reduce computation having been previously executed is stored in the buffers 30A and 30B. Accordingly, the DMA unit 32 issues a fetch request twice in order to respectively store data in the buffers 30A and 30B. Data included in the fetch responses from the memory 24 of the node ND0 is respectively stored in the buffers 30A and 30B ((c) of FIG. 13). Note whether the buffer 30A or 30B stores therein the data read from the memory 24 is determined due to the control by the sequencer 38 illustrated in FIG. 5.

The DMA unit 32 of the node ND0 issues, in order to read data used in the reduce computation from the memories 24 of the other nodes ND1-ND3, a reduce Get request to each of the other nodes ND1-ND3 ((d) of FIG. 13). The reduce Get request is one example of a transfer request for data. In order to cause each node to transfer data stored in each of the buffers 30A and 30B, A reduce Get request is issued twice for every nodes ND1-ND3.

The DMA units 32 of the other nodes ND1-ND3 each issue a fetch request to the memory 24 of the local node, based on the reduce Get request from the node ND0 ((e) of FIG. 13). The DMA units 32 of the other nodes ND1-ND3 ND3 each receive data included in a fetch response from the memory 24 of the local node ((f) of FIG. 13). The DMA units 32 of the other nodes ND1-ND3 each issue a reduce Get response in order to transfer the data included in the fetch response to the node ND0 (master) ((g) of FIG. 13).

In the actual operation, a fetch request is issued to the memory controller 22 illustrated in FIG. 5. The memory controller 22 having received the fetch request reads data from the memory 24, and outputs a fetch response including the read data to the DMA unit 32. A store&Next fetch request, which is described later, is also issued to the memory controller 22, and a store&Next fetch response is outputted from the memory controller 22.

The DMA unit 32 of the node ND0 stores data included in the reduce Get responses from the memories 24 of the other nodes ND1-ND3 in each of the buffers 30A and 30B ((h) of FIG. 13). The memories 24 of the nodes ND0-ND3 respectively become the states illustrated in FIG. 11, by the operations as a master and a slave by the respective nodes ND0-ND3.

The node ND0 that operates as a master activates the reduce DMA and issues reduce Get requests to the other nodes ND1-ND3 to allow the node ND0 to wait reduce Get responses from the other nodes ND1-ND3. This allows the sequencer 38 of the node ND0 that operates as a master to collect, by performing control similar to that by the existing sequencer, target data for the reduce computation having been held in the memories 24 of the other nodes ND1-ND3.

After the storage of data from the memory 24 of each of the nodes ND0-ND3 to the buffers 30A and 30B has been completed, the computation unit 28 of the node ND0 executes the reduce computation using, for example, data held in the buffer 30A ((i) of FIG. 13). The computation unit 28 repeatedly executes such processing of taking out data from the buffer 30A to execute the reduce computation, and transferring result data obtained due to the reduce computation to the store buffer 40c and the transmission buffer 46a illustrated in FIG. 5. The buffers 30A and 30B each having a smaller access latency compared with that of the memory 24 is capable of executing the reading of target data for the computation at high speed. Note that the computation unit 28 may repeatedly execute such processing of transferring (overwriting) result data obtained due to the reduce computation to the buffer 30A from which the target data for the computation has been taken-out.

The DMA unit 32 of the node ND0 issues a store&Next fetch request based on the completion of the reduce computation for all the data stored in the buffer 30A ((j) of FIG. 13). The store&Next fetch request includes result data of the reduce computation stored in the store buffer 40c. Further, when the result data of the reduce computation is stored in the buffer 30A, the store&Next fetch request includes result data of the reduce computation stored in the buffer 30A. The memory controller 22 stores, based on the store&Next fetch request, the result data included in the store&Next fetch request in the memory 24.

Moreover, the memory controller 22 reads, based on the store&Next fetch request, data to be used in the next reduce computation from the memory 24, and outputs a store&Next fetch response including the read data. Data included in the store&Next fetch response is stored, based on the control by the sequencer 38, in the buffer 30A that has already outputted the result data of the reduce computation ((k) of FIG. 13).

In addition, the DMA unit 32 of the node ND0 issues, in order to store the result data of the reduce computation in the memories 24 of the other nodes ND1-ND3, reduce BC&Get requests to the other nodes ND1-ND3 ((I) of FIG. 13). The reduce BC&Get request includes the result data of the reduce computation stored in the transmission buffer 46a. Further, when the result data of the reduce computation is stored in the buffer 30A, the reduce BC&Get request includes result data of the reduce computation stored in the buffer 30A. The reduce BC&Get request is one example of the storage reading request.

As having been explained in FIG. 12, result data of the reduce computation executed in each node ND is transferred to the other nodes NDs. In other words, packets each including result data of the reduce computation have common information, except the destination and the storage address. Accordingly, broadcasting the result data of the reduce computation by the reduce BC&Get requests makes it possible to simplify the transmission control of the DMA unit 32, compared with the case where packets to be transmitted to the respective nodes ND1-ND3 are respectively generated.

The DMA units 32 of the other nodes ND1-ND3 each issue, based on the reduce BC&Get request from the node ND0, a store&Next fetch request to the memory 24 of the local node ((m) of FIG. 13). The operation based on the store&Next fetch request in each of the other nodes ND1-ND3 is similar to the operation based on the store&Next fetch request in the node ND0 described above. The DMA units 32 of the other nodes ND1-ND3 each receive data included in a store&Next fetch response from the memory 24 ((n) of FIG. 13).

The DMA units 32 of the other nodes ND1-ND3 each issue a reduce BC&Get response in order to transfer the data included in the store&Next fetch response to the node ND0 (master) ((o) of FIG. 13). Data included in the reduce BC&Get response is stored, based on the control by the sequencer 38, in the buffer 30A that has already outputted the result data of the reduce computation ((p) of FIG. 13).

When data for which the reduce computation has not been executed remains in the memory 24, the reduce BC&Get request is issued to make it possible to process storing the result data of the reduce computation in the memory 24 and reading data for the next reduce computation with one packet. Similarly, the store&Next fetch request is issued to make it possible to process storing the result data of the reduce computation in the memory 24 and reading data for the next reduce computation with one packet.

The computation unit 28 of the node ND0 executes the reduce computation using data held in the buffer 30B while the storage of data to the buffer 30A is being processed ((q) of FIG. 13). In other words, the transfer of data to the buffer 30A is executed in the background of the reduce computation by the computation unit 28. The computation unit 28 repeatedly executes such processing of taking out data from the buffer 30B to compute the data, and storing result data obtained due to the computation in the store buffer 40c and the transmission buffer 46a illustrated in FIG. 5.

In FIG. 14, the DMA unit 32 of the node ND0 issues, in order to store result data obtained due to the execution of the reduce computation by the computation unit 28 in the memory 24 of the local node, a store&Next fetch request ((a) of FIG. 14).

The memory controller 22 stores result data included in the store&Next fetch request in the memory 24, reads data to be used in the next reduce computation from the memory 24, and outputs a store&Next fetch response including the read data ((b) of FIG. 14). Data included in the store&Next fetch response is stored in the buffer 30B based on the control by the sequencer 38 ((b) of FIG. 14). In other words, the sequencer 38 alternately stores data included in a plurality of store&Next fetch responses in the buffers 30A and 30B.

Moreover, the DMA unit 32 of the node ND0 issues, in order to store the result data of the reduce computation in the memories 24 of the other nodes ND1-ND3, reduce BC&Get requests to the other nodes ND1-ND3 ((c) of FIG. 14). The operation of each of the other nodes ND1-ND3 based on the reduce BC&Get request is similar to the operation that has been explained in (I), (m), and (n) of FIG. 13. Data included in the reduce BC&Get response is stored in the buffer 30B based on the control by the sequencer 38 ((d) of FIG. 14).

The computation unit 28 of the node ND0 executes the reduce computation using data held in the buffer 30A while the storage of data to the buffer 30B is being processed ((e) of FIG. 14). Thereafter, the reduce computation is executed alternately using data held in either one of the buffers 30A and 30B, and in the background of the reduce computation, new data is transferred to the other of the buffers 30A and 30B that is not used in the reduce computation.

The DMA unit 32 of the node ND0 issues a store request, for example, after the last reduce computation using the data held in the buffer 30A has been executed, in order to store result data in the memory 24 of the local node ((f) of FIG. 14). The memory controller 22 stores result data included in the store request in the memory 24. Moreover, the DMA unit 32 of the node ND0 issues reduce BC requests to the other nodes ND1-ND3 ((g) of FIG. 14). The DMA units 32 of the other nodes ND1-ND3 each issue, based on the reduce BC request from the node ND0, a store request in order to store result data in the memory 24 of the local node ((h) of FIG. 14). Further, result data of the last reduce computation using the data held in the buffer 30A is stored in the memory 24 of each of the nodes ND0-ND3.

While the result data of the last reduce computation using the data held in the buffer 30A is being transferred to the memory 24 of each of the local nodes ND0-ND3, the computation unit 28 of the node ND0 executes the reduce computation using data held in the buffer 30B ((i) of FIG. 14). The DMA unit 32 of the node ND0 issues, for example, after the last reduce computation using data held in the buffer 30B has been executed, a store request to the local node and reduce BC requests to the other nodes ND1-ND3 ((j) and (k) of FIG. 14). Further, result data of the last reduce computation using the data held in the buffer 30B is stored in the memory 24 of each of the nodes ND0-ND3. Note that in FIG. 14, the illustration of a store response that is issued based on the store request and a reduce BC response that is issued based on the reduce BC request is omitted.

Note that in FIGS. 13 and 14, instead of the reduce BC&Get request, a reduce BC request and a plurality of reduce Get requests may be successively issued, and a reduce Put request and a reduce Get request may be issued to the other nodes ND1-ND3. In FIG. 14, instead of the store&Next fetch request, a store request and a fetch request may be successively issued.

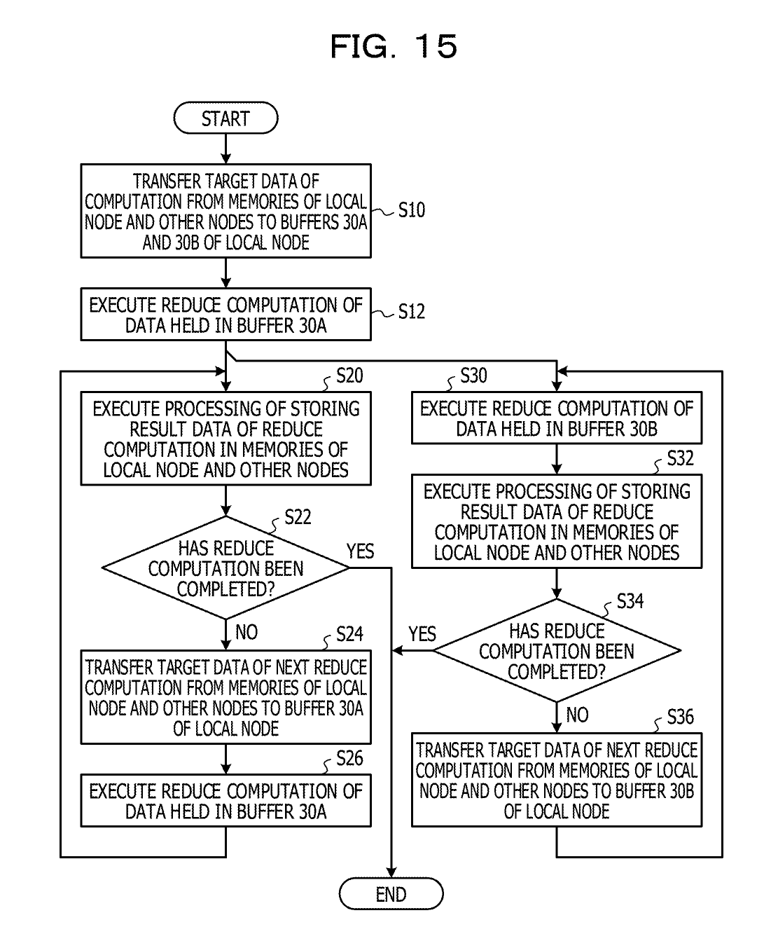

FIG. 15 illustrates one example of an operation flow of the master illustrated in FIGS. 13 and 14. The operation flow illustrated in FIG. 15 is started based on the computation processing such as the FMA operation that the computation units 20 of all the nodes ND0-ND3 execute.

Firstly, at an operation S10, the master transfers target data for the reduce computation from the memory 24 of the local node and the memories 24 of the other nodes to either one of the buffers 30A and 30B of the local node. At an operation S12, the master executes the reduce computation on data held in the buffer 30A. Thereafter, the master executes in parallel a transfer operation of data with respect to the buffer 30A and a reduce computation for data held in the buffer 30B, and a transfer operation of data with respect to the buffer 30B and a reduce computation for data held in the buffer 30A. In other words, the master executes in parallel the operation at operations S20, S22, S24, and S26, and the operation at operations S30, S32, S34, and S36.

At the operation S20, the master executes processing of storing result data of the reduce computation using data held in the buffer 30A in the memory 24 of the local node and the memories 24 of the other nodes. At the operation S22, if the reduce computation of the data held in the memory 24 using the buffer 30A has not been completed, the master shifts the operation to the operation S24. If the reduce computation of the data held in the memory 24 using the buffer 30A has been completed, the master completes the processing of the reduce computation using the buffer 30A.

At the operation S24, the master transfers target data for the next reduce computation from the memory 24 of the local node and the memories 24 of the other nodes to the buffer 30A of the local node. At the operation S26, the master executes the reduce computation on data held in the buffer 30A, and shifts the operation to the operation S20.

At the operation S30, the master executes the reduce computation on data held in the buffer 30B. At the operation S32, the master executes processing of storing result data of the reduce computation using data held in the buffer 30B in the memory 24 of the local node and the memories 24 of the other nodes. At the operation S34, if the reduce computation of the data held in the memory 24 using the buffer 30B has not been completed, the master shifts the operation to the operation S36. On the other hand, if the reduce computation of the data held in the memory 24 using the buffer 30B has been completed, the master completes the processing of reduce computation using the buffer 30B.

At the operation S36, the master transfers target data for the next reduce computation from the memory 24 of the local node and the memories 24 of the other nodes the buffer 30B of the local node, and shifts the operation to the operation S30.

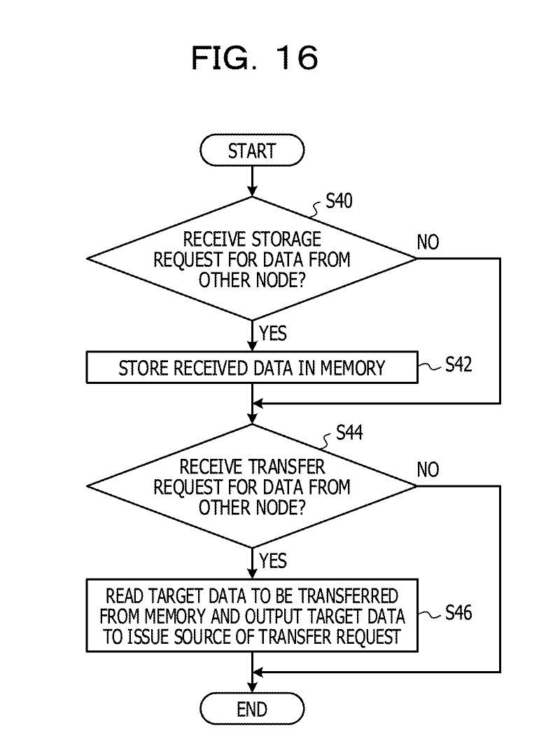

FIG. 16 illustrates one example of an operation flow of the slave illustrated in FIGS. 13 and 14. The operation flow illustrated in FIG. 16 is started with a predetermined frequency.

At an operation S40, the slave shifts the operation to an operation S42 if receiving a storage request for data from the other node, and shifts the operation to an operation S44 if receiving no storage request for data from the other node. Herein, the storage request for data is the reduce BC&Get request or the reduce BC request illustrated in FIGS. 13 and 14.

At the operation S42, the slave stores the data received from the other node in the memory 24, and shifts the operation to the operation S44. At the operation S44, the slave shifts the operation to an operation S46 if receiving a transfer request for data from the other node, and completes the operation if receiving no transfer request for data from the other node. The transfer request for data is the reduce Get request or the reduce BC&Get request illustrated in FIGS. 13 and 14. At the operation S46, the slave reads target data to be transferred from the memory 24 and outputs the target data to the issue source of the transfer request, and ends the operation.

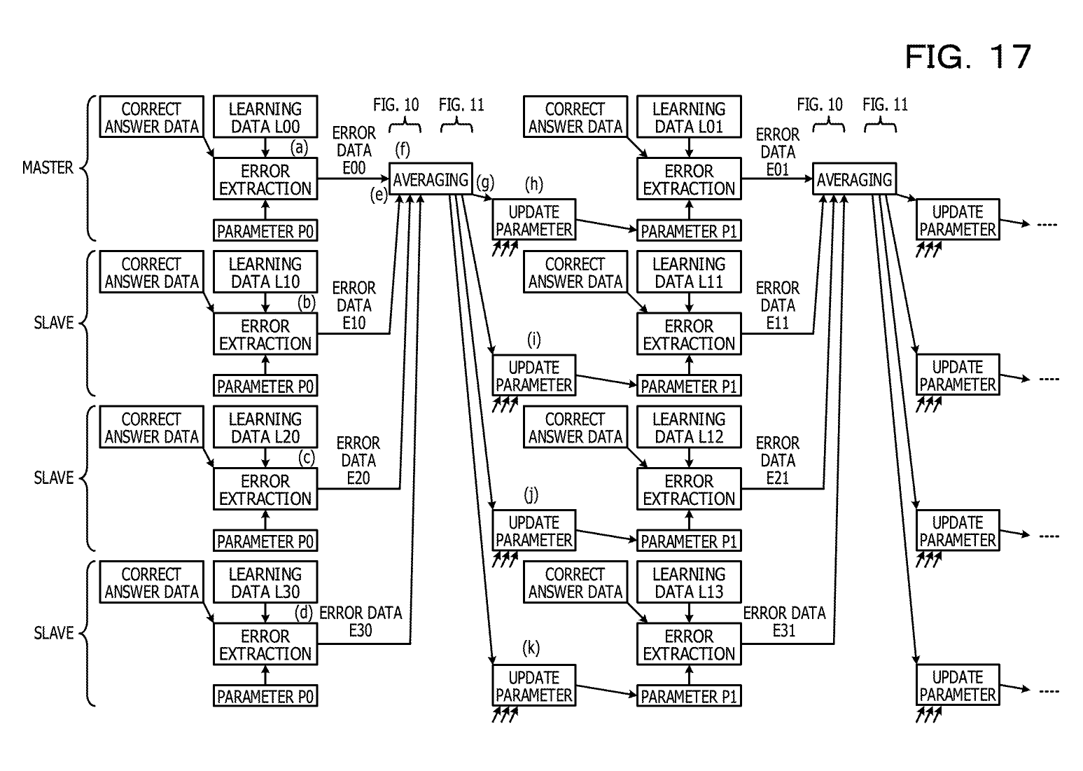

FIG. 17 illustrates one example of deep learning that the information processing system illustrated in FIG. 4 executes. Processing illustrated in FIG. 17 is executed in parallel in each of the nodes ND0-ND3. In other words, when the node ND0 operates as a master, the nodes ND1-ND3 each operate as a slave, and when the node ND1 operates as a master, the nodes ND0, ND2, and ND3 each operate as a slave. When the node ND2 operates as a master, the nodes ND0, ND1, and ND3 each operate as a slave, and when the node ND3 operates as a master, the nodes ND0-ND2 each operate as a slave. In the following, the example in which the node ND0 operates as a master, and the nodes ND1-ND3 each operate as a slave is explained.

The node ND0 (master) uses the computation unit 20 to execute the computation of learning data L00 such as a plurality pieces of image data and a parameter P0 calculated in advance, thereby extracting a feature of the learning data L00. The node ND0 uses the computation unit 20 to compare the extracted feature with correct answer data, thereby extracting error data E00 ((a) of FIG. 17).

The other nodes ND1-ND3 (slave) respectively extract, based on learning data L10-L30 and the parameter P0, features of the learning data, and compare the extracted features with the correct answer data, thereby extracting error data E10-E30 ((b), (c), and (d) of FIG. 17). The learning data L00, L10, L20, and L30 are different in the different nodes ND0-ND3, and the parameter P0 and the correct answer data are common to the nodes ND0-ND3.

The error data E00, E10, E20, and E30 that the respective nodes ND0-ND3 extract are stored in the memory 24 of each of the nodes ND0-ND3 as illustrated in FIG. 11. In FIG. 11, data “0-00”, “0-01”, and others respectively indicate elements of the error data. The error data E00, E10, E20, and E30 is respectively calculated based on the learning data L00, L10, L20, and L30 different from one another, therefore, values of the error data E00, E10, E20, and E30 vary. Accordingly, averaging processing in which the error data E00, E10, E20, and E30 is averaged in order to be used in the update of a parameter for next learning is executed.

For example, the node ND0 collects the error data E00 extracted by the local node, and the error data E10, E20, and E30 extracted by the nodes ND1-ND3 ((e) of FIG. 17). The error data E00, E10, E20, and E30 is transferred, as illustrated in FIG. 11, due to the operation by the DMA unit 32, from the memories 24 of the respective nodes ND0-ND3 to the buffer 30A or 30B of the node ND0 (master). Further, the node ND0 uses the computation unit 28 to execute processing of averaging the elements of the error data E00, E10, E20, and E30 having been transferred to the buffer 30A or 30B ((f) of FIG. 17). In other words, the reduce computation is executed.

The node ND0 transfers data (result data of the reduce computation) obtained by the averaging to the memories 24 of the nodes ND0-ND3, as illustrated in FIG. 12 ((g) of FIG. 17). The data obtained by the averaging is “0-00′”, “0-01′”, and others illustrated in FIG. 12. As illustrated in FIG. 11, while the averaging processing of the error data E00-E30 by the node ND0 is being executed, each of the nodes ND1-ND3 executes averaging processing of another error data, and distributes the averaged error data to the other nodes NDs.

Thereafter, each of the nodes ND0-ND3 uses the computation unit 20 to execute processing of updating the parameter based on the error data averaged in the local node ND and the other nodes NDs ((h), (i), (j), and (k) of FIG. 17). Further, each of the nodes ND0-ND3 executes the computation of the next learning data L01 (or any one of L11, L12, and L13) and an updated parameter P1, thereby extracting new error data E01 (or any one of E11, E12, and E13). Thereafter, similar to (e), (f), and (g) of FIG. 17, the collection of the error data E01, E11, E21, and E31, the averaging processing, and the distribution of the averaged error data are executed. In this manner, processing of extracting a feature of learning data based on a parameter, processing of extracting error data by comparing the extracted feature with correct answer data, and processing of updating the parameter using the extracted error data are repeatedly executed, whereby the degree of learning becomes proficient.

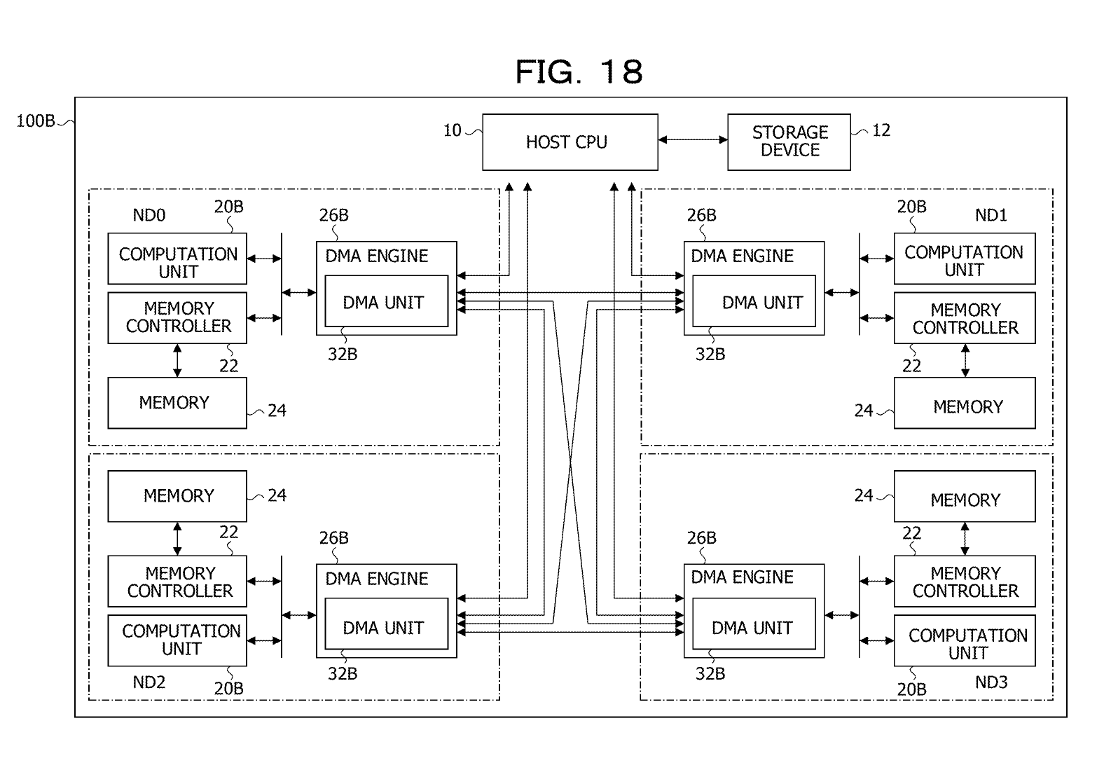

FIG. 18 illustrates one example of another information processing system different from the information processing system illustrated in FIG. 4. The same elements as in FIG. 4 are assigned with the same reference numerals, and detailed explanations are omitted. In an information processing system 100B illustrated in FIG. 18, the configuration of each node ND (ND0-ND3) is different from the configuration of each node ND (ND0-ND3) illustrated in FIG. 4.

Each node ND includes a computation unit 20B, the memory controller 22, a DMA engine 26B including the memory 24 and a DMA unit 32B. The DMA engine 26B does not include the computation unit 28 and the buffers 30A and 30B illustrated in FIG. 4. The DMA unit 32B controls the transfer of data among the memory 24 of the local node ND, the memories 24 of the other nodes NDs, and the storage device 12.

In the information processing system 100B illustrated in FIG. 18, each node ND uses the DMA unit 32B to transfer data used in the reduce computation from the memories 24 of the other nodes NDs to the memory 24 of the local node ND. Each node ND causes the computation unit 20B to operate, thereby executing the reduce computation on data held in the memory 24 and storing result data obtained due to the reduce computation in the memory 24 of the local node ND. The reduce computation is executed in the transfer unit of data (for example, 16 MB) by the DMA unit 32B. Each node ND uses the DMA unit 32B to distribute result data of the reduce computation to the memories 24 of the other nodes NDs.

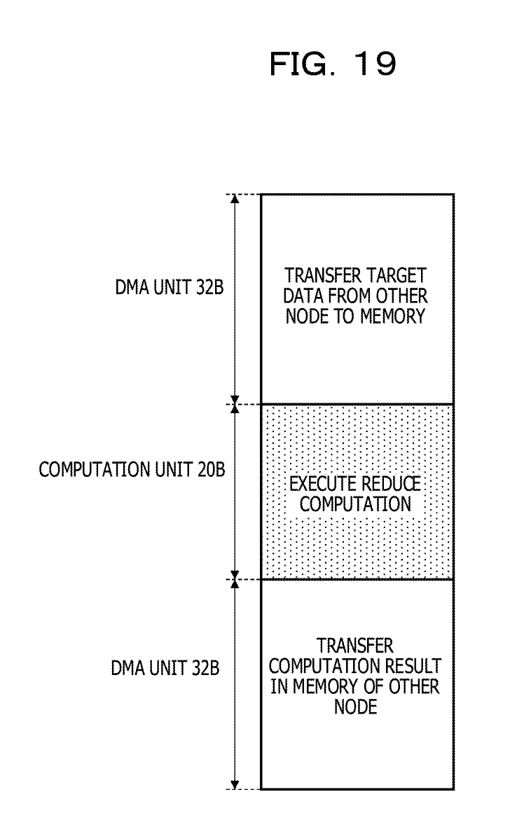

FIG. 19 illustrates one example of an operation of the DMA engine illustrated in FIG. 18. The DMA unit 32B transfers target data for the reduce computation (for example, 4 MB) held in the memory 24 of the other node ND to the memory 24 of the local node ND, thereby collecting data of 16 MB to the memory 24. Next, the computation unit 20B executes the reduce computation using the data held in the memory 24, and stores result data obtained by the execution in the memory 24. Next, the DMA unit 32B distributes result data to the memories 24 of the other nodes NDs.

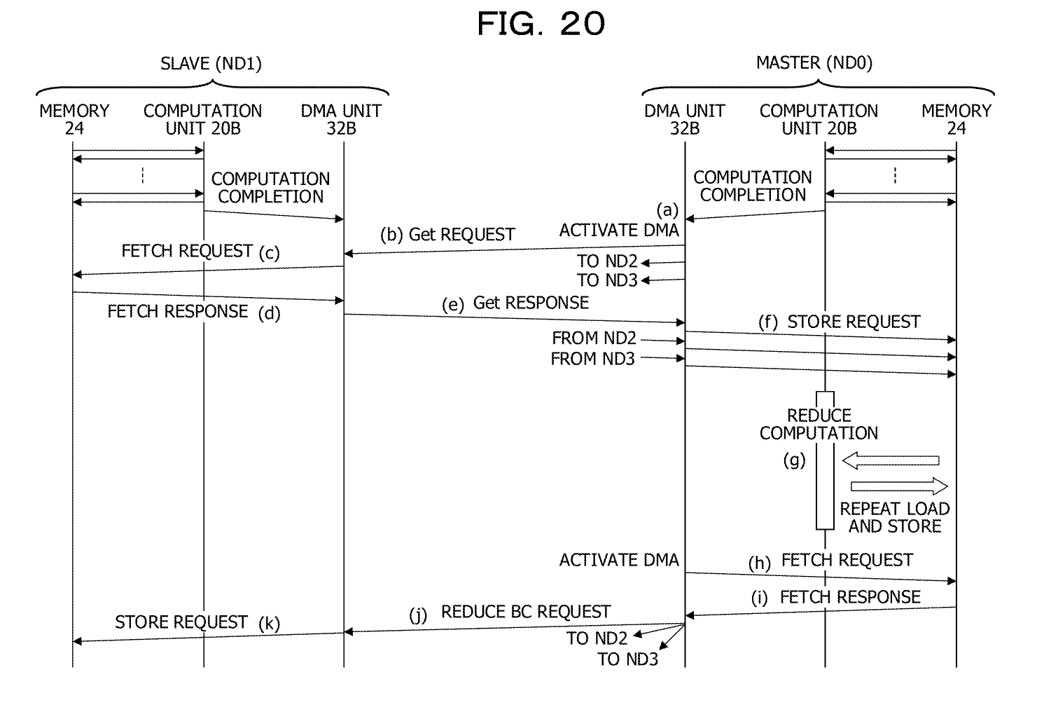

FIG. 20 illustrates one example of an operation of the information processing system 100B illustrated in FIG. 18. Detailed explanations of the operations similar to those illustrated in FIGS. 13 and 14 are omitted. Each of the nodes ND0-ND3 executes in parallel the operation as a master and the operation as a slave. FIG. 20 illustrates, for easy understanding of the explanation, the operation as a master by the node ND0 and the operation as a slave by the node ND1. Moreover, similar to FIGS. 13 and 14, the operation of the memory controller 22 is omitted.

Similar to FIG. 13, the nodes ND0-ND3 cause the computation units 20B to operate, thereby executing in parallel the computation processing such as the FMA operation, and wait so as to match the completions of the computation processing through the barrier synchronization and the like. The operation by the computation unit 20B causes data used in the reduce computation to be stored in the memory 24. The DMA unit 32B of the node ND0 activates, based on the completion of the computation processing by the computation units 20 of the local node ND0 and the other nodes ND1-ND3, DMA, which is described below, in order to execute the reduce computation ((a) of FIG. 20).

The DMA unit 32B of the node ND0 issues, in order to read data used in the reduce computation from the memories 24 of the nodes ND1-ND3, a Get request to each of the nodes ND1-ND3 ((b) of FIG. 20). For example, the transfer length of data designated by each Get request is 4 MB.

The DMA unit 32B of the node ND1 issues a fetch request to the memory 24 of the local node, based on the Get request from the node ND0 ((c) of FIG. 20). The DMA unit 32B of the node ND1 receives data included in a fetch response from the memory 24 ((d) of FIG. 20). The DMA unit 32B of the node ND1 issues a Get response in order to transfer the data included in the fetch response to the node ND0 (master) ((e) of FIG. 20). The DMA units 32B of the nodes ND2 and ND3 execute processing the same as the processing illustrated in (c) and (d) of FIG. 20.

The DMA unit 32B of the node ND0 issues, in order to store the data included in the Get responses from the memories 24 of the nodes ND1-ND3 in the memory 24, a store request based on the reception of the data from each of the nodes ND1-ND3 ((f) of FIG. 20).

After the target data for the reduce computation has been transferred to the memory 24, the computation unit 20B of the node ND0 executes the reduce computation by loading the data held in the memory 24, and stores the result data obtained by the execution of the reduce computation in the memory 24 ((g) of FIG. 20). Further, the load of the data from the memory 24, the reduce computation, and the storage of the result data in the memory 24 are repeatedly executed with respect to the data of 16 MB.

When the execution of the reduce computation for all the target data held in the memory 24 has been completed, the DMA unit 32B of the node ND0 activates DMA, and transfers result data (4 MB) from the memory 24 of the local node ND to the memories 24 of the other nodes NDs. In other words, the DMA unit 32B of the node ND0 issues a fetch request to the memory 24 of the local node ND, and receives result data included in a fetch response from the memory 24 of the local node ND ((h) and (i) of FIG. 20). Further, the DMA unit 32B of the node ND0 issue reduce BC requests each including the received result data to the nodes ND1-ND3 ((j) of FIG. 20).

The DMA unit 32B of the node ND1 issues a store request, in order to store the result data included in the reduce BC request in the memory 24 of the local node ND ((k) of FIG. 20). The DMA units 32B of the nodes ND2 and ND3 each also issue a store request similar to (k) of FIG. 20. Further, the result data of the reduce computation executed in the node ND0 is distributed to the nodes ND1-ND3.

In the information processing system 100B illustrated in FIG. 18, the target data for the reduce computation is stored in the memory 24, therefore, the use amount of the memory area is increased, compared with the information processing system 100A illustrated in FIG. 4. The transfer of the target data for the reduce computation to the memory 24 and the reduce computation are executed with different timings and without being overlapped with each other. This results in the larger latency between after the activation of the DMA after the computation processing such as the FMA operation has been completed and before the distribution of the result data of the predetermined amount reduce computations to the other nodes ND is completed, compared with the information processing system 100A illustrated in FIG. 4.

The memory 24 is accessed every time the reduce computation is executed, therefore, the access frequency to the memory 24 becomes higher, compared with the information processing system 100A illustrated in FIG. 4. This suppresses the throughput of access to the memory 24 by another computation that the computation unit 20B executes. In addition, the reduce computation is executed in the computation unit 20B, therefore, the computation unit 20B is unable to execute another computation while the reduce computation is being executed. The suppression of the throughput of access to the memory 24 and the execution of the reduce computation in the computation unit 20B lower the computation performance of each of the nodes ND0-ND3, compared with the information processing system 100A illustrated in FIG. 4.

Also in from FIGS. 4 to 17, the similar effect in the embodiment illustrated in FIG. 1 may be obtained. For example, the computation unit 28 that executes the reduce computation is provided independent of the computation unit 20 to allow the computation unit 20 to execute the computation to generate target data for the reduce computation and the like without being affected by the operation of the reduce computation by the computation unit 28. For example, it is possible to suppress the processing performance of another computation from lowering due to the allreduce processing that the computation unit 28 executes. The computation unit 28 may execute the reduce computation without being affected by the operation of computation to generate target data for the reduce computation by the computation unit 20. In addition, the reduce computation is executed without the main storage device 3 being accessed, therefore, it is possible to suppress the access efficiency to the main storage device 3 due to the execution of the reduce computation from lowering.

The target data for the reduce computation is transferred to the buffers 30A and 30B each having a smaller access latency compared with the memory 24, therefore, it is possible to shorten the transfer time of target data compared with the case where target data is transferred to the memory 24. This allows the reduce computation to start earlier. It is possible execute the reading of target data from the buffers 30A and 30B at high speed, compared with the reading target data from the memory 24. This may shorten the execution period of the reduce computation and start the transfer of result data earlier. As a result, it is possible to transfer earlier target data for the next reduce computation to the buffers 30A and 30B, and start earlier the next reduce computation.

In from FIGS. 4 to 17, the buffers 30A and 30B are used to allow the reduce computation and the data transfer with respect to the memory 24 to be executed in parallel. As a result, it is possible to continuously and continually execute the reduce computation, and shorten the execution time of the reduce processing, compared with the case where the reduce computation and the data transfer with respect to the memory 24 are alternately executed.

The node ND0 that operates as a master activates the reduce DMA and issues reduce Get requests to the other nodes ND1-ND3 to allow the node ND0 to wait reduce Get responses from the other nodes ND1-ND3. This allows the sequencer 38 of the node ND0 that operates as a master to collect, by the control similar to that by the existing sequencer, target data for the reduce computation having been held in the memories 24 of the other nodes ND1-ND3.

When data for which the reduce computation has not been executed remains in the memory 24, the reduce BC&Get request is issued to make it possible to process storing the result data of the reduce computation in the memory 24 and reading data for the next reduce computation with one packet. Similarly, the store&Next fetch request is issued to make it possible to process storing the result data of the reduce computation in the memory 24 and reading data for the next reduce computation with one packet.

The result data of the reduce computation is transferred to the other nodes NDs using packets for broadcast such as reduce BC&Get requests to make it possible to simplify the transfer control of the DMA unit 32, compared with the case where packets to the other nodes NDs are individually generated.

Setting the storage capacity of each of the buffers 30A and 30B based on the size of the payload of the packet to allow the minimum scale of each of the buffers 30A and 30B. As a result, it is possible to achieve the minimum increase in the circuit scale of the DMA engine 26 even when the buffers 30A and 30B are provided in the DMA engine 26.

With the foregoing, it is possible to improve the processing performance of the information processing system 100A that executes allreduce processing.

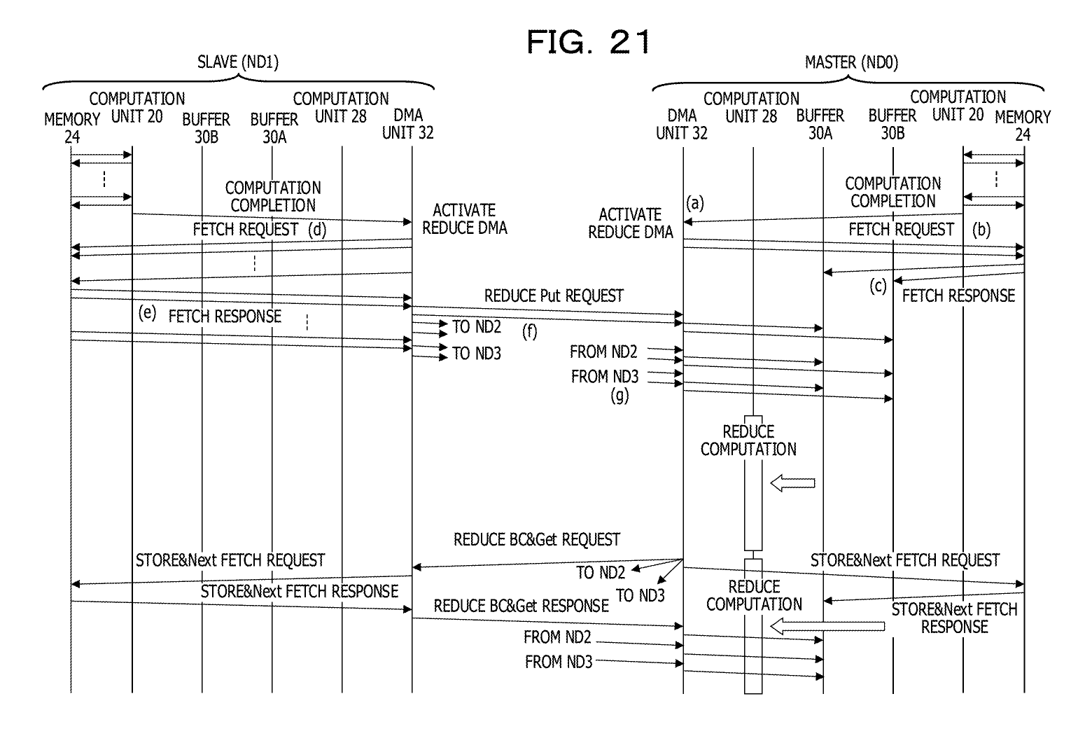

FIG. 21 illustrates one example of an operation of the information processing system in another embodiment. The elements the same as or similar to those described in the embodiment illustrated in from FIGS. 4 to 20 are assigned with the same reference numerals, and detailed explanations thereof are omitted. The configuration and the function of the information processing system that executes the operation illustrated in FIG. 21 are similar to the configuration and the function of the information processing system 100A illustrated in FIGS. 4 and 5, except that a part of the control by the sequencer 38 illustrated in FIG. 5 is different. In FIG. 21, similar to FIG. 13, the operation as a master by the node ND0 and the operation as a slave by the node ND1 are illustrated.

The nodes ND0-ND3 cause the computation units 20 to operate, thereby executing in parallel the computation processing such as the FMA operation, and wait so as to match the completions of the computation processing through the barrier synchronization and the like. The operation by the computation unit 20 causes data used in the reduce computation to be stored in the memory 24, as illustrated in FIG. 11.

The DMA unit 32 of the node ND0 activates reduce DMA, similar to FIG. 13, based on the completion of the computation processing by the computation unit 20 of each of the nodes ND0-ND3 ((a) of FIG. 21). The DMA unit 32 of the node ND0 issues a fetch request in order to read data used in the reduce computation from the memory 24 of the local node ((b) of FIG. 21). The DMA unit 32 issues a fetch request twice in order to respectively store data in the buffers 30A and 30B. Data included in the fetch responses is respectively stored in the buffers 30A and 30B ((c) of FIG. 21).

Meanwhile, the DMA unit 32 of the node ND1 issues, based on the completion of the computation processing by the computation unit 20 of each of the nodes ND0-ND3, a fetch request to the memory 24 in order to read target data for the reduce computation ((d) of FIG. 21). The fetch request is issued six times so as to correspond to the buffers 30A and 30B of the nodes ND0, ND2, and ND3.

The DMA unit 32 of the node ND1 receives data included in a fetch response from the memory 24 ((e) of FIG. 21). The DMA unit 32 of the node ND1 data issues a reduce Put request twice with respect to each of the nodes ND0, ND2, and ND3 in order to transfer data included in the fetch response to each of the nodes ND0, ND2, and ND3 ((f) of FIG. 21). The nodes ND2 and ND3 respectively operate similarly to the node ND1, and each issue a reduce Put request twice in order to transfer target data for the reduce computation to the node ND0 ((g) of FIG. 21). The operations thereafter are similar to those in FIGS. 13 and 14.

The nodes ND1-ND3 that operate as a slave also operate as a master, and thus may issue, based on the issue of fetch requests as the master to the memory 24 of the local node, fetch requests for reduce Put request. In FIG. 21, the slave may take out target data for the reduce computation from the memory 24 and transfer the target data to the master without waiting a reduce BC&Get request from the master illustrated in FIG. 13. This may accelerate the timing when the storage of the target data for the reduce computation in the buffers 30A and 30B has completed compared with FIG. 13, and start the first reduce computation earlier. As a result, compared with the information processing system 100A illustrated in FIG. 4, it is possible to shorten the time taken for the allreduce processing. For example, in deep learning illustrated in FIG. 17, it is possible to shorten the time taken for the collection of the error data E01, E11, E21, and E31, the averaging processing, and the distribution of the averaged error data.

Also in FIG. 21, the similar effect in the embodiment illustrated in from FIGS. 1 to 20 may be obtained. In addition, in the embodiment illustrated in FIG. 21, the slave spontaneously transfers target data for the reduce computation to master based on the completion of the computation processing such as the FMA operation, therefore, it is possible to shorten the time taken for the allreduce processing.

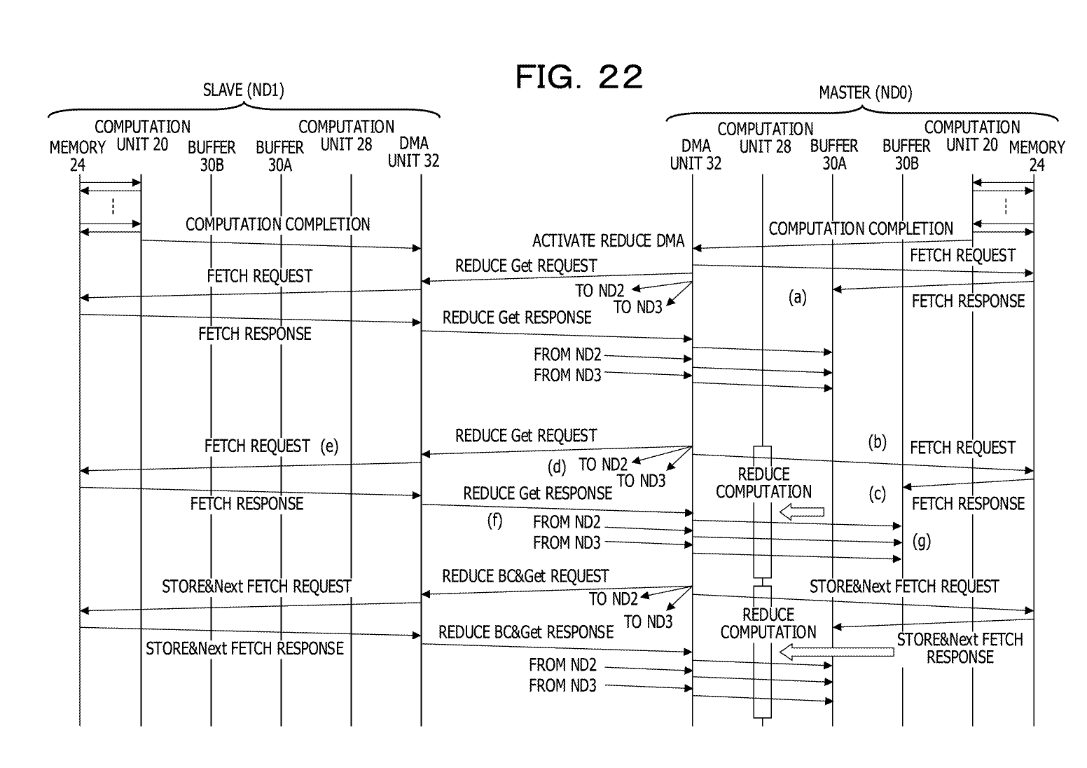

FIG. 22 illustrates one example of an operation of the information processing system. Detailed explanations of the operations the same as or similar to those illustrated in FIG. 13 are omitted. The elements the same as or similar to those described in the embodiment illustrated in from FIGS. 4 to 20 are assigned with the same reference numerals, and detailed explanations thereof are omitted. The configuration and the function of the information processing system that executes the operation illustrated in FIG. 22 are similar to the configuration and the function of the information processing system 100A illustrated in FIGS. 4 and 5, except that a part of the control by the sequencer 38 illustrated in FIG. 5 is different. In FIG. 22, similar to FIG. 13, the operation as a master by the node ND0 and the operation as a slave by the node ND1 are illustrated.

In this embodiment, based on the completion of the computation processing by the computation unit 20 of each of the nodes ND0-ND3, similar to FIG. 13, the transfer of data used in the reduce computation from the memory 24 of each of the nodes ND0-ND3 to the buffer 30A has executed ((a) of FIG. 22). Note that the transfer of data used in the reduce computation from the memory 24 of each of the nodes ND0-ND3 to the buffer 30B is not executed at this time point. In FIG. 22, the operations except the transfer processing of data to the buffer 30B are the same as those in FIG. 13.

The DMA unit 32 of the node ND0 (master) issues a fetch request for storing data in the buffer 30B while the computation unit 28 is executing the reduce computation using the data held in the buffer 30A ((b) of FIG. 22). Data included in the fetch response is stored in the buffer 30B while the reduce computation is executing ((c) of FIG. 22).

The DMA unit 32 of the node ND0 issues, while the computation unit 28 is executing the reduce computation using the data held in the buffer 30A, reduce Get requests for storing data in the buffer 30B to the other nodes ND1-ND3 ((d) of FIG. 22). The DMA units 32 of the other nodes ND1-ND3 (slave) each issue a fetch request to each memory 24, based on the reduce Get request for storing data in the buffer 30B ((e) of FIG. 22).

The DMA units 32 of the other nodes ND1-ND3 each issue a reduce Get response including the data read from the memory 24 based on a fetch response to the node ND0 ((f) of FIG. 22). Further, while the computation unit 28 is executing the reduce computation using the data held in the buffer 30A, the data transferred from the other nodes ND1-ND3 is stored in the buffer 30B ((g) of FIG. 22).

Subsequent to the operation illustrated in FIG. 22, the operation illustrated in FIG. 14 is executed. In the operation illustrated in FIG. 22, data is transferred to the buffer 30A based on the completion of the computation processing by the computation unit 20, and while the reduce computation is being executed with the data transferred to the buffer 30A being used, a fetch request and a reduce Get request for storing data in the buffer 30B are issued. The DMA operation for storing data in the buffer 30A is executed in a concentrated manner based on the completion of the computation processing by the computation unit 20 to make it possible to complete the storage of data to the buffer 30A earlier compared with that in FIG. 13. As a result, compared with FIG. 13, it is possible to start earlier the first reduce computation, and improve the efficiency of the allreduce processing.

As in the foregoing, also in FIG. 22, an effect similar to that of the embodiment illustrated in FIGS. 1 and 20 may be obtained. In addition, in the embodiment illustrated in FIG. 22, the DMA unit 32 executes the first transfer of data to the buffer 30B after the computation processing by the computation unit 20 has been completed, during the reduce computation of the data held in the buffer 30A by the computation unit 28. The DMA operation for storing data in the buffer 30A is executed in a concentrated manner to make it possible to complete the storage of data to the buffer 30A earlier compared with that in FIG. 13. As a result, compared with FIG. 13, it is possible to start earlier the first reduce computation, and improve the efficiency of the allreduce processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a first information processing apparatus; and
a second information processing apparatus,
the first information processing apparatus includes:
a computation processing device that executes a first computation;
a main storage device that stores data; and
a control device that controls transfer of data among the first information processing apparatus and the second information processing apparatus,
the control device includes:
a computation processor that executes a second computation;
a buffer that holds data to be used in the second computation that the computation processor executes; and
a transfer controller that controls transfer of data from the main storage device to the buffer and transfer of data from a different main storage device included in the second information processing apparatus to the buffer, and controls transfer of result data of the second computation to the main storage device and transfer of the result data of the second computation to the different main storage device.

2. The information processing system according to claim 1, wherein
the buffer includes a plurality of sub-buffers, and
the transfer controller controls, while the computation processor executes the second computation using the data held in one of the plurality of sub-buffers, transfer of data from the main storage device and the different main storage device to one of the plurality of sub-buffers.

3. The information processing system according to claim 1, wherein
the computation processing device generates, by executing the first computation, the data to be used in the second computation by the computation processor, and stores the generated data in the main storage device, and
the transfer controller:
issues, based on completion of the first computation by the computation processing device, a transfer request for data to a different transfer controller of the second information processing apparatus;
outputs data read from the main storage device based on a transfer request from the second information processing apparatus to the second information processing apparatus; and
stores the data transferred from the different transfer controller in response to the transfer request for data to the different transfer controller in the buffer.

4. The information processing system according to claim 1, wherein
the computation processing device generates, by executing the first computation, the data to be used in the second computation by the computation processor, and stores the generated data in the main storage device, and
the transfer controller:
reads, based on completion of the first computation by the computation processing device, the data to be used in the second computation by a different computation processor of the second information processing apparatus from the different main storage device;
outputs the read data to the different transfer controller; and
stores the data received from the different transfer controller in the buffer.

5. The information processing system according to claim 1, wherein
the transfer controller:
issues, when the data to be used in the second computation remains in the different main storage device, a storage reading request including an instruction to store result data of the second computation in the different main storage device and an instruction to read the data to be used in the second computation from the different main storage device, to the second information processing apparatus; and
stores, based on another storage reading request from the second information processing apparatus, the result data received with the another storage reading request in the main storage device, and reads data to be used in the second computation by the different computation processor from the main storage device and outputs the data to be used in the second computation by the different computation processor to the second information processing apparatus.

6. The information processing system according to claim 1, wherein the transfer controller broadcasts result data of the second computation to different information processing apparatuses in the information processing system and including the second information processing apparatus.

7. The information processing system according to claim 1, wherein
data that is transferred among different information processing apparatuses in the information processing system and including the second information processing apparatus is transferred by packets, and
the buffer has a storage capacity that allows data of a maximum size transferable by each packet to be held.

8. An information processing apparatus comprising:
a computation processing device that executes a first computation;
a main storage device that stores data; and
a control device that controls transfer of data among the first information processing apparatus and a second information processing apparatus,
the control device includes:
a computation processor that executes a second computation;
a buffer that holds data to be used in the second computation that the computation processor executes; and
a transfer controller that controls transfer of data from the main storage device to the buffer and transfer of data from a different main storage device included in the second information processing apparatus to the buffer, and controls transfer of result data of the second computation to the main storage device and transfer of the result data of the second computation to the different main storage device.

9. The information processing apparatus according to claim 8, wherein
the buffer includes a plurality of sub-buffers, and
the transfer controller controls, while the computation processor executes the second computation using the data held in one of the plurality of sub-buffers, transfer of data from the main storage device and the different main storage device to one of the plurality of sub-buffers.

10. The information processing apparatus according to claim 8, wherein
the computation processing device generates, by executing the first computation, the data to be used in the second computation by the computation processor, and stores the generated data in the main storage device, and
the transfer controller:
issues, based on completion of the first computation by the computation processing device, a transfer request for data to a different transfer controller of the second information processing apparatus;
outputs data read from the main storage device based on a transfer request from the second information processing apparatus to the second information processing apparatus; and
stores the data transferred from the different transfer controller in response to the transfer request for data to the different transfer controller in the buffer.

11. The information processing apparatus according to claim 8, wherein
the computation processing device generates, by executing the first computation, the data to be used in the second computation by the computation processor, and stores the generated data in the main storage device, and
the transfer controller:
reads, based on completion of the first computation by the computation processing device, the data to be used in the second computation by a different computation processor of the second information processing apparatus from the different main storage device;
outputs the read data to the different transfer controller; and
stores the data received from the different transfer controller in the buffer.

12. The information processing apparatus according to claim 8, wherein
the transfer controller:
issues, when the data to be used in the second computation remains in the different main storage device, a storage reading request including an instruction to store result data of the second computation in the different main storage device and an instruction to read the data to be used in the second computation from the different main storage device, to the second information processing apparatus; and
stores, based on another storage reading request from the second information processing apparatus, the result data received with the another storage reading request in the main storage device, and reads data to be used in the second computation by the different computation processor from the main storage device and outputs the data to be used in the second computation by the different computation processor to the second information processing apparatus.

13. The information processing apparatus according to claim 8, wherein the transfer controller broadcasts result data of the second computation to different information processing apparatuses in an information processing system and including the second information processing apparatus.

14. The information processing apparatus according to claim 8, wherein
data that is transferred among different information processing apparatuses in an information processing system and including the second information processing apparatus is transferred by packets, and
the buffer has a storage capacity that allows data of a maximum size transferable by each packet to be held.

15. A method of controlling an information processing system comprising:
executing, by a computation processing device, a first computation;
controlling, by a control device, transfer of data among a first information processing apparatus and a second information processing apparatus,
executing, by a computation processor in the first information apparatus, a second computation;
controlling, by a transfer controller in the first information processing apparatus, transfer of data from a main storage device in the first information processing apparatus to a buffer in the first information processing apparatus, which holds data to be used in the second computation, and transfer of data from a different main storage device included in the second information processing apparatus to the buffer; and
controlling transfer of result data of the second computation to the main storage device and transfer of the result data of the second computation to the different main storage device.

16. The method according to claim 15, further comprising:
generating, by executing the first computation, the data to be used in the second computation by the computation processor;
storing the generated data in the main storage device;
issuing, based on completion of the first computation by the computation processing device, a transfer request for data to a different transfer controller of the second information processing apparatus;
outputting data read from the main storage device based on a transfer request from the second information processing apparatus to the second information processing apparatus; and
storing the data transferred from the different transfer controller in response to the transfer request for data to the different transfer controller in the buffer.

17. The method according to claim 15, further comprising:
generating, by executing the first computation, the data to be used in the second computation by the computation processor;
storing the generated data in the main storage device;
reading, based on completion of the first computation by the computation processing device, the data to be used in the second computation by a different computation processor of the second information processing apparatus from the different main storage device;
outputting the read data to the different transfer controller; and
storing the data received from the different transfer controller in the buffer.

18. The method according to claim 15, further comprising:
issuing, when the data to be used in the second computation remains in the different main storage device, a storage reading request including an instruction to store result data of the second computation in the different main storage device and an instruction to read the data to be used in the second computation from the different main storage device, to the second information processing apparatus; and
storing, based on another storage reading request from the second information processing apparatus, the result data received with the another storage reading request in the main storage device, and reads data to be used in the second computation by the different computation processor from the main storage device and outputs the data to be used in the second computation by the different computation processor to the second information processing apparatus.
